(19) United States
(12) Patent Application Publication
(10) Pub. No.: US 2021/0096979 A1
(43) Pub. Date: Apr. 1, 2021

(54) CLIENT AUTOMATED TRANSACTION TESTING PORTAL

(71) Applicant: VISA INTERNATIONAL SERVICE ASSOCIATION, SAN FRANCISCO, CA (US)

(72) Inventors: John Fasheh, Foster City, CA (US); Gouranga Seth, Singapore (SG); Saswata Das, Singapore (SG); Chirag Jayantilal Patel, Singapore (SG); Terrance Hill, Highlands Ranch, CO (US); Twila Blume, Ashburn, VA (US); Lee Tang, Foster City, CA (US); Haseen Ahmad, San Francisco, CA (US)

(21) Appl. No.: 16/589,997

(22) Filed: Oct. 1, 2019

(51) Int. Cl. G06F 11/36; G06F 16/9535; G06F 16/957; G06Q 20/32; G06Q 20/34; G06K 7/10

(52) U.S. Cl. CPC G06F 11/3688; G06F 11/3664; G06F 11/3684; G06K 7/10366; G06F 16/9577; G06Q 20/325; G06Q 20/352; G06F 16/9535

(57) ABSTRACT

A web-based payment testing and virtualization environment provides a web portal with auto-generated profile detail in response to login credentials. In addition, in the test environment for a particular client account, the environment further applies intelligence to provide a dedicated processor testing without user interventions or configurations. Existing approaches require pre-configurations of the processor conditions or environments before executing the testing.

### TECHNICAL FIELD

Embodiments discussed herein generally relate to online-based management, testing, and verification of transactions and payment accepting devices.

### BACKGROUND

A given payment processing network constantly handles billions of transactions from merchants, issuers, acquirers, merchants' issuers, and acquirer processors. Over time, merchants may replace point-of-sale (POS) devices or card reader devices. The new replacements also need to be certified and tested before merchants and the payment processing network are confident that transactions may be processed smoothly and without glitches.

Existing practices have been allowing ATM or POS vendors or manufacturers to use a static or pre-configured application issued by the payment processing network server. These parties may then register through the client-side application to perform the testing. As part of the test, the client-side application may then connect to a new POS or ATM device to a peripheral port, such as a USB connection. The application next connects to one of the processors or processing applications hosted by the payment processing network server. The parties may perform the testing of the reader and once that is completed, the reader is ready for use.

Unfortunately, there are various drawbacks of such approach. For example, the parties need to wait for updates for the application and sometimes failure to install the updates, the application may not be operational. Further, the payment processing network server may need to issue various versions of the application so that it is compatible with local devices that the parties are using. In addition, when performing the actual test, the application may need to wait for the availability of the processor to perform the test. Moreover, the application is pre-configured with the logical mapping between the testing processor or condition and the card reader each time when client-side application is connected or the testing or verification is done.

Furthermore, the application typically relies on HTTP as a transport layer to benefit from existing infrastructure (proxies, filtering, and authentication. However, the trade-offs between efficiency and reliability in using HTTP results in problems with bidirectional communications via HTTP as HTTP was not designed for bidirectional communication (see [RFC6202] for further discussion).

Moreover, the application is limited in its capabilities. Other than testing the devices, the device manufacturer or its agent could not engage testing of transactions that could be processed by the device. The testing would not be available as there was an expectation that the device should work by default or errors may be remedied after the device enters the live processing.

Therefore, embodiments attempt to create a technical solution to address the deficiencies of the challenges above.

### SUMMARY

Embodiments create a technical solution to the above challenges by creating a web-based solution that enables a user of a web-based portal (e.g., a party that needs to test and simulate payment transactions and payment accepting devices) to create a profile to accommodate various payment accepting devices (e.g., card readers) for testing, verification, and/or activation of transactions. In addition, aspects of embodiments enable the manufacturer or its agent (collectively referred to as “user”) to specific or configure data, parameters or conditions to test transactions with the device. The user may, based on aspects of embodiments, create test transactions from both acquirer's and issuer's perspective before the device is ready to service live transactions. Moreover, the profile enables session-based pairing between the card readers to a dynamic selection of processors, stations, etc., for convenient testing of the payment accepting devices.

### BRIEF DESCRIPTION OF THE DRAWINGS

Persons of ordinary skill in the art may appreciate that elements in the figures are illustrated for simplicity and clarity so not all connections and options have been shown. For example, common but well-understood elements that are useful or necessary in a commercially feasible embodiment may often not be depicted in order to facilitate a less obstructed view of these various embodiments of the present disclosure. It may be further appreciated that certain actions and/or steps may be described or depicted in a particular order of occurrence while those skilled in the art may understand that such specificity with respect to sequence is not actually required. It may also be understood that the terms and expressions used herein may be defined with respect to their corresponding respective areas of inquiry and study except where specific meanings have otherwise been set forth herein.

FIG. 1 is a system diagram for a self-testing portal according to one embodiment.

FIGS. 2A to 2F are a screenshot illustrating a graphical user interface (GUI) for accessing and creating a database entity for transaction testing according to one embodiment.

FIGS. 3A to 3B are diagrams illustrating message flow according to one embodiment.

FIG. 4 is a screenshot illustrating a graphical user interface (GUI) for configure a testing profile according to one embodiment.

FIG. 5 is a screenshot illustrating a graphical user interface (GUI) for enabling a user to execute client test scripts according to one embodiment.

FIG. 6 is a screenshot illustrating a graphical user interface (GUI) for reviewing transaction logs according to one embodiment.

FIGS. 7A-7B are diagrams illustrating a client host connector creating a virtual testing environment where a system is acting as an acquirer according to one embodiment.

FIGS. 8A-8B are diagrams illustrating a client host connector creating a virtual testing environment where a system is acting as an issuer according to one embodiment.

FIGS. 9A to 9D are screenshots illustrating various specifications for the user according to one embodiment.

FIG. 10 illustrates a diagram of a subsystem that may conveniently handle the card reader testing tasks according to one embodiment.

FIG. 11A illustrates an exemplary GUI as shown a web browser for handling such testing requests from the user according to one embodiment.

FIG. 11B illustrates an exemplary GUI showing an output screen of a thin client application according to one embodiment.

FIG. 12 is a flowchart illustrating a computerized method according to one embodiment.

FIG. 13 is a diagram illustrating a portable computing device according to one embodiment.

FIG. 14 is a diagram illustrating a computing device according to one embodiment.

### DETAILED DESCRIPTION

Embodiments may now be described more fully with reference to the accompanying drawings, which form a part hereof, and which show, by way of illustration, specific exemplary embodiments which may be practiced. These illustrations and exemplary embodiments may be presented with the understanding that the present disclosure is an exemplification of the principles of one or more embodiments and may not be intended to limit any one of the embodiments illustrated. Embodiments may be embodied in many different forms and should not be construed as limited to the embodiments set forth herein; rather, these embodiments are provided so that this disclosure may be thorough and complete, and may fully convey the scope of embodiments to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description may, therefore, not to be taken in a limiting sense.

Embodiments expand the capabilities of the Websocket Protocol which enables two-way communication between a client's running untrusted code in a controlled environment to a remote host that has opted-in to communications from that code. In such a security model, which is commonly used by web browsers, the protocol may include an opening handshake followed by basic message framing, layered over TCP. Aspects of various embodiments provide a mechanism for browser-based applications that need two-way communication with servers that does not rely on opening multiple HTTP connections. In such an embodiment, the Websocket Protocol designed to supersede existing bidirectional communication technologies that use HTTP as a transport layer to benefit from existing infrastructure (proxies, filtering, and authentication). The Websocket Protocol attempts to address the goals of existing bidirectional HTTP technologies in the context of the existing HTTP infrastructure; as such, it is designed to work over HTTP ports 80 and 443 as well as to support HTTP proxies and intermediaries, even if this implies some complexity specific to the current environment. However, aspects of embodiments do not limit Websocket to HTTP. In one embodiment, a simpler handshake over a dedicated port without reinventing the entire protocol may be used.

In one embodiment, the simpler handshake may be desirable in situations where traffic patterns of interactive messaging may not closely match standard HTTP traffic. Under the existing HTTP scheme, the interactive messaging may induce usual loads on some components. As such, the simpler handshake solution may be desirable over HTTP.

Aspects of embodiments further provide a reporting function available to business and end users that shows at least:

Who tested

What was tested

What passed

What failed

Detailed outcome explanation

Request/response pairs must be delivered to originator.

Moreover, the testing result may be connected or transmitted to a of the payment processing networking. In another embodiment, the result may be offloaded to the certification management service offline to a client host.

The solution must include a client profiling system that allows clients to choose parameter(s) and article(s) through a GUI that is selected according to their need. These parameters include selection of region (singular or multiple), client type, and member type.

In one aspect, a master database generator that is responsible for generating the databases from the inputs provided for an individual article number. This will also include the creation of a superset of all possible fields and usages master template, MTI (message type indicator) template, and transaction template.

All required combinations possible may be generated for the article number.

Similar inputs may be applied and provided for all other article numbers as applicable per BER Global Technical Letter and Implementation Guide (GTLIG).

There may be a test script and case generator that can generate client specific scripts and test cases according to the selections made in the client test profile.

The report generator will be able to generate reports based on the unique user id.

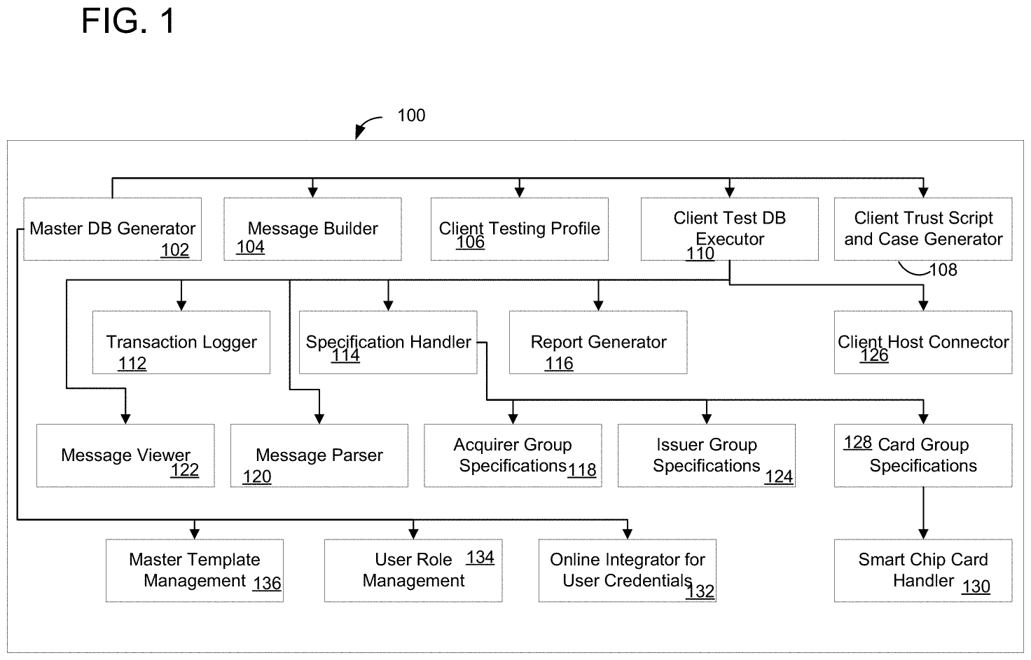

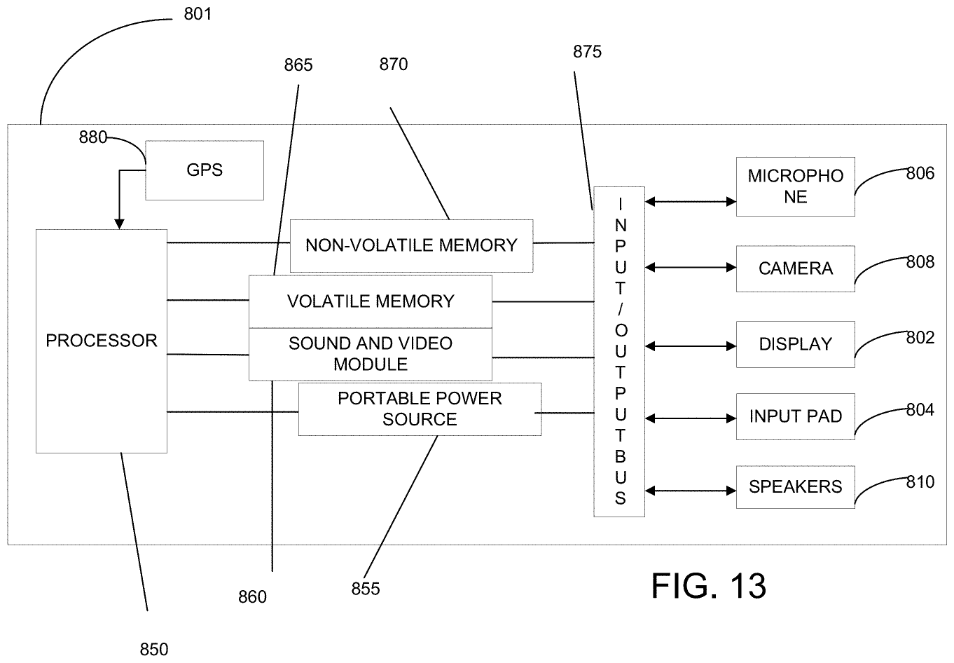

Referring to FIG. 1, a diagram illustrates a system 100 overall view according to one embodiment. In one embodiment, the system 100 may include a server, such as one shown in FIG. 13. For example, the system 100 may be in an execution environment with a payment processing network such that the system 100 includes one or more servers distributed in various physical locations. In one embodiment, the one or more servers of the system 100 may process various payment transactions. In addition as to be discussed below, the servers 100 may also process testing requests from merchants, issuers, acquirers, merchants' issuers, acquirer's processors, or other affiliated parties all over the world. In one example, such test may include test for new card readers.

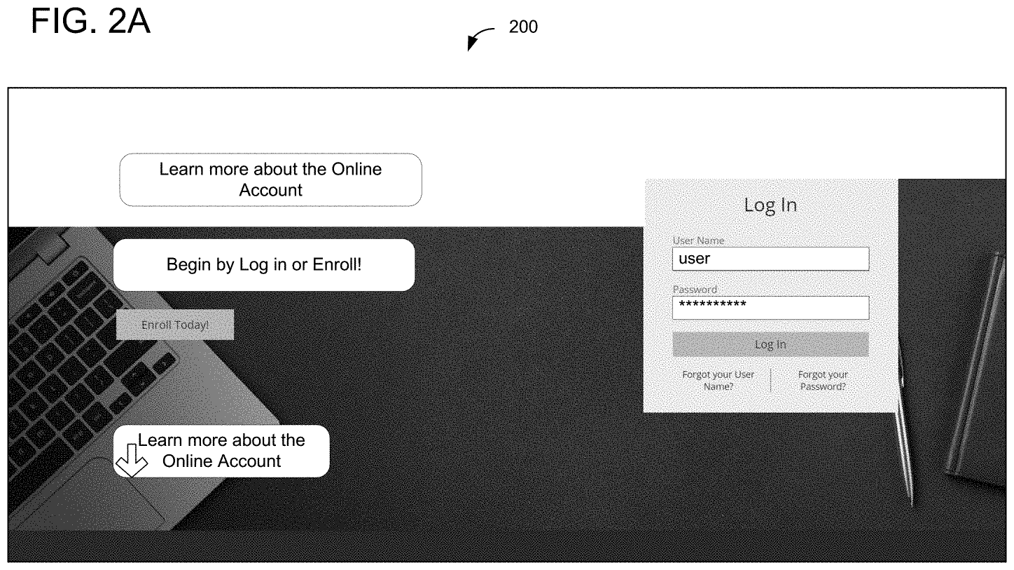

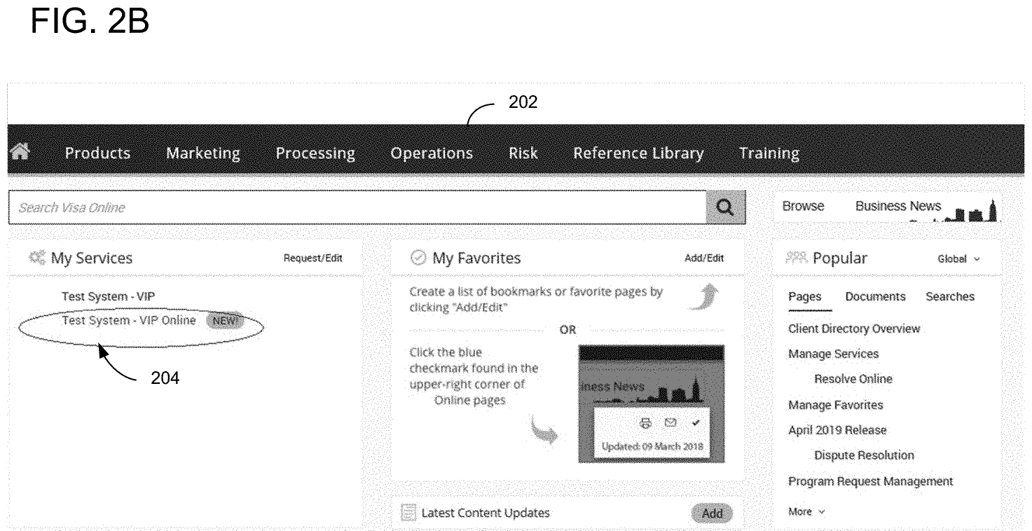

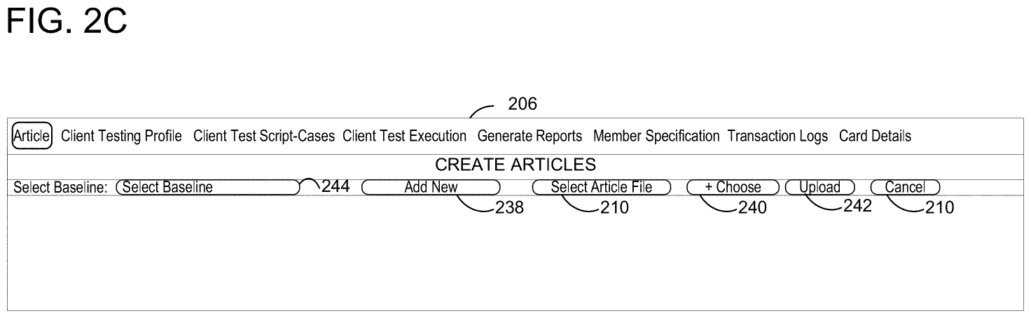

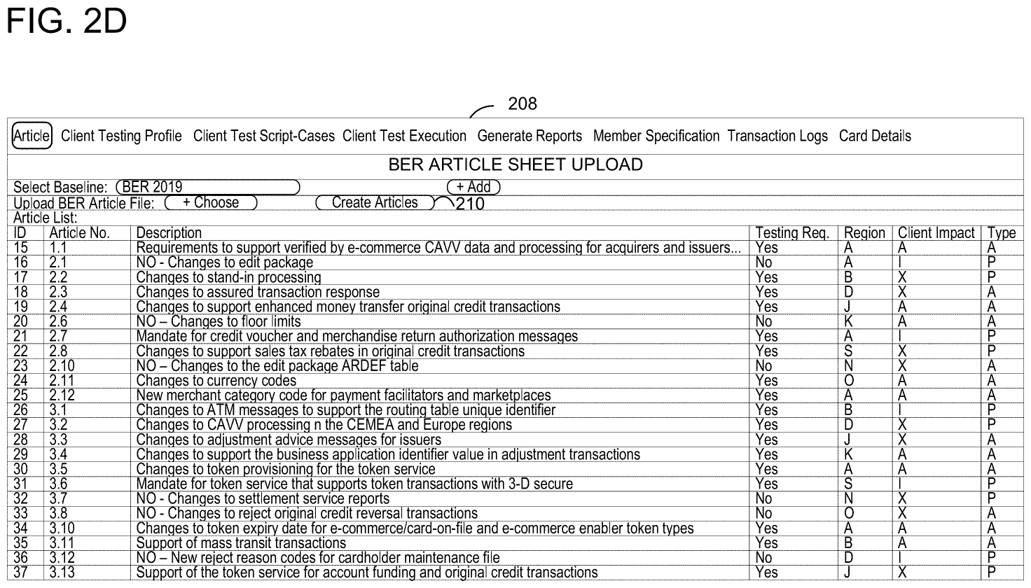

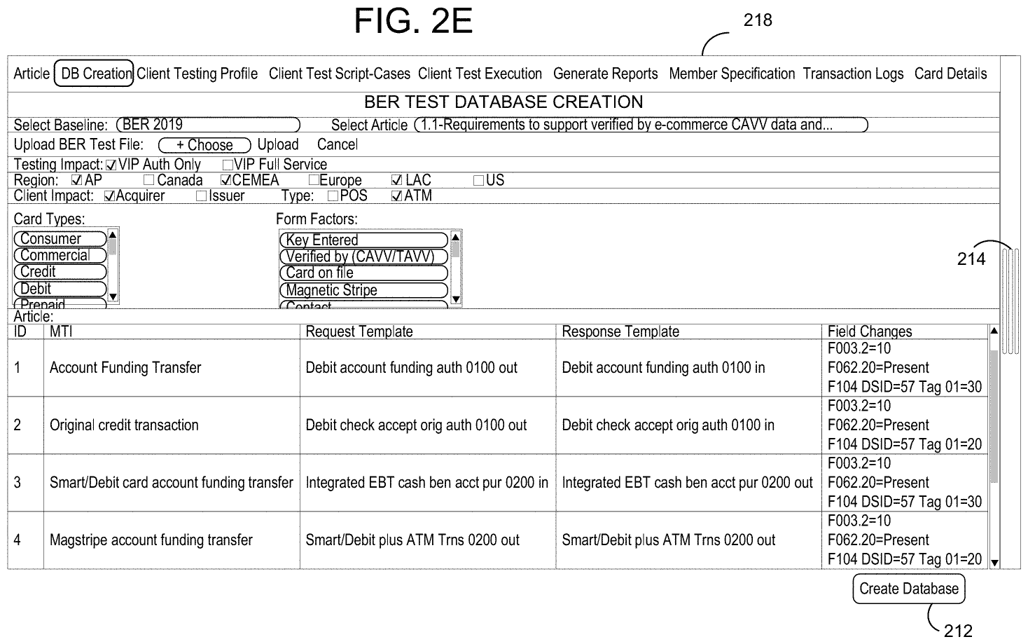

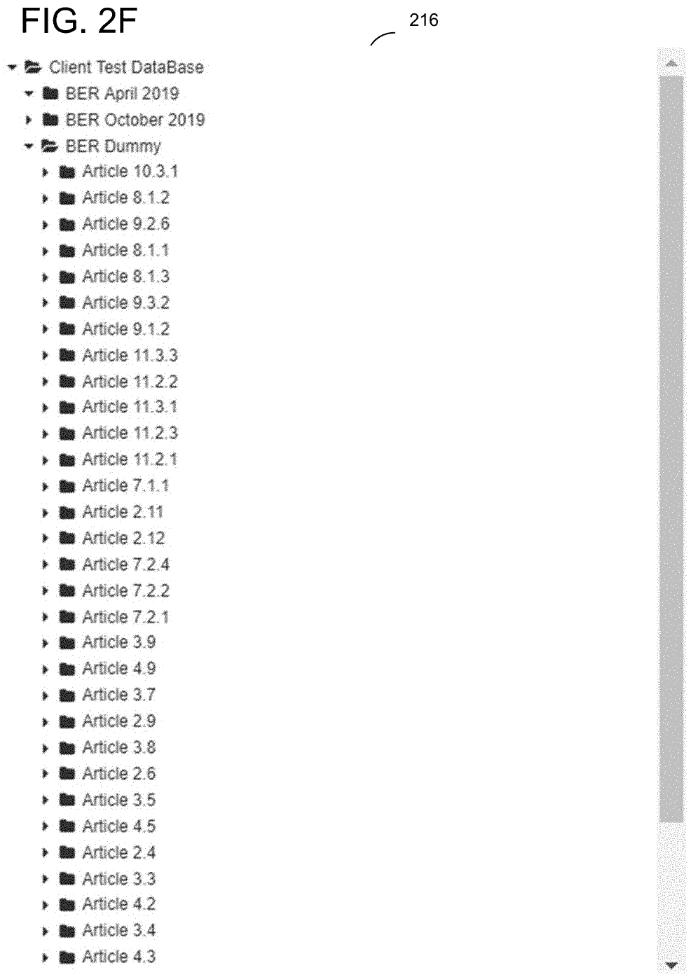

In another embodiment, the system 100 may first require a user to login (such as creating a user credential and password) to access various services described below. For example, the system 100 may include a login screen or portal 200 in FIG. 2A where the user may enroll or sign in. In another embodiment, the system 100 may have one portal for various services and the services provided below may only be a portion of all services provided by the system 100. As such, the system 100 may provide another portal 202 where the user may select, after logged in via the portal 200 in FIG. 2A, a selection 204 to access the services below.

In one embodiment, the system 100 may be connected, via wired or wireless devices, to the servers, and databases that are accessible by the servers. In another embodiment, for handling transaction testing requests, the system 100 may include a master DB generator 102. In one example, the master database (“DB”) generator 102 may be responsible for generating the databases from the inputs provided for that particular individual article number. In another embodiment, the master DB generator 102 may further create a superset of all possible fields and usages master template, message type indicator (MTI) template, and transaction template.

In one embodiment, the master DB generator 102 include five main parts:

1. Baseline Node Creation
To Create the Baseline Node of particular BER

2. Article Sheet Upload
To Upload the BER Excel Sheet

3. Stripy Sheet upload with each Article
To Upload the Stripy Sheet for each Article

4. Master DB generation for each article
Generate the associate DB and Baseline Tree

5. Message Building while Master DB Generation.
Message Building while creating the Master DB

In one embodiment, FIG. 2C illustrates a simplified GUI 206 for baseline node creation. The user may create a new baseline by selecting an “ADD” button 238 or select an existing baseline by either invocating a “CHOOSE” button 240 or an “UPLOAD” button 242. The user may also select a “CANCEL” button 246 to cancel the creation of the baseline node. Once created or chosen from an existing one, the baseline node DB may be identified in a field 244.

Once user has created a baseline or chose an existing baseline, the user may create or upload a BER Article Sheet, which may summarize all the changes of that particular BER. Referring now to FIG. 2D, an exemplary graphical user interface (GUI) 206 for article upload according to one embodiment. In one embodiment, the user may upload a list of Articles (e.g., POS or ATM devices) to the portal 208 via a spreadsheet. In another embodiment, the user may create a new article item via the portal by selecting a “creating article” button 210.

In another embodiment, the user may upload another spreadsheet for each article once the Admin user select the particular BER and corresponding Article Number in Master DB generation Page. Referring now to FIG. 2E, an exemplary GUI 218 of a portal for database creation by the master DG generator 102 may be illustrated. In one embodiment, the GUI 218 may include one or more configurable parameters for the user to configure before a BER test database is created. In one embodiment, the user may select a button 212 “CREATE DATABASE” to create the desirable database.

Once the user uploads the spreadsheet for each article successfully, the portal 218 may populate the default choice automatically. In one embodiment, the user may interact with the portal 218 to review the details before selecting the button 212. In another embodiment, the master DB generator 102 may create the database based on the parameters included in each spreadsheet.

In addition, the portal 218 may include additional add-on panel for displaying the database structure. Via a selection or an invocation of an indicia or indicator 214, for example, referring now to FIG. 2F, an exemplary GUI 216 illustrates a folder tree illustrating the database that has been created. It is to be understood that the GUI 216 may be a permanent display portion of the portal 208 without departing from the spirit and scope of the embodiments.

In one embodiment, the master DB generator 102 may use the tree structure shown in the GUI 216 to build messages for each of the entities or nodes based on the parameters provided.

In one embodiment, the article may include a card reader. In another embodiment, the card reader may include a point-of-sale (POS) device, an automated teller machine (ATM), a contact-based card reader, a contactless card reader, a smart chip reader, or the like. In one embodiment, the master DB generator 102 may include one or more of the following inter components that may be triggered, executed, or called during building the database:

Message Builder 104: To build the message from DB generator parameter;

Client Testing Profile 106: Allowing Clients to choose parameters and articles through graphical user interface (GUI) to select as per their need. In one embodiment, these parameters include selection of region (singular or multiple), client type, and member type;

Client Test Script & Case Generator 108: To generate the client specific script & test case as per selection in client Test Profile;

Client Test DB Executor 110: Running the Transactions and displaying the transaction Logs on the run time.

In one embodiment, the following components mentioned below may be triggered, executed, or called internally with this components:

Certification Management Service-HOST Connector 126: To Connect with merchant services or external Host;

Transaction Message Parser 120: To Parse the incoming and outgoing messages;

Transaction Message Viewer 122: To View the incoming and outgoing messages;

Transaction Logger 112: To Log the transaction incoming and outgoing messages run by individual clients. In one embodiment, the retention of the log entries may be configured according to the data retention policy of the system 100;

Report Generator 116: To generate report based on UNIQUE User id—In one embodiment, the system 100 may include administrator access team that may have privilege to look transaction logs for all users;

Specifications Handler 114: To set the member specifications based on member profile. The aim of this component in one embodiment includes getting the following specifications as mentioned below:

Acquirer Group specifications 118: To set the required field values of this group as set by user admin or individual user;

Issuer Group specifications 124: To set the required field values of this group as set by user admin or individual user; and

Card Group specifications 128: To set the required field values read from Card by default.

In one embodiment, the card group specifications 128 may trigger, execute, or call the smart chip card handler 130 to obtain the card values based on various form factor. In on embodiment, the form factor may include contact-based and contactless cards. In another embodiment, the form factor may include barcode or quick response (QR) code.

In one embodiment, the smart chip card handler 130 may obtain the chip card data from attached device and pass the data to a browser.

In yet another embodiment, apart from the above major components, one or more other components may be included in the system 100:

Online Integrator 132: To get the required user information from a server like UserId, Region, etc., post online authentication;

User Role Management 134: To manage application level user role authorization post online authentication having some access level privileges; and

Master Template Management 136: To manage the various Master Templates along with various look up tables, usage tables, field values etc., to build the actual transaction message as needed.

In one embodiment, the Master DB Generator 102 may generate any associated DB of the scripts based on the Articles number provided. Before more details of the operations of the master DB generator 102, aspects of embodiments may need be discussed first. For example, the user role management 134, the master template management 136, and the online integrator 132 may be described below:

The user role management 134 may be a set of computer-executable instructions incorporated into software program application, tools, or components for execution by the one or more servers of the system 100. In one embodiment, the user role management 134 may enable different user roles:

The New user to get into to the system as inactive user;

The User Admin/System Admin to approve and activate the inactive user;

The System Admin/User Admin to block a user;

The System Admin may make a user to User Admin; and

The System Admin may block a User Admin.

In one embodiment, it is to be understood that all users managed by the user role management 134 must have a valid user login credential. In addition, in one embodiment, the user role may also need to have a proper subscription for accessing this tool.

In one embodiment, the user role management 134 may provide one or more of the functions as described:

A. User Entry/Creation:

In this function, the requirements for the User for user creation are as follows—

The User has logged in to an online portal page using his/her online credentials.

The user clicked the token services link from ONLINE page.

For New User: The System 100 may display the page prompting that User has successfully logged into the system as inactive user—

A new entry may be created in database with UserId, UserName, UserEmail (from online account), status (as enabled) and UserRole as Normal User

A mail may be triggered to System/User Admins with the information of new user and to enable the user for accessing an integrated payment online system. In one embodiment, as discussed above, the system 100 may include payment processing components or sub-systems to be incorporated.

User may be redirected to a page showing the message “Please ask User Admin to provide access to the system”

B. For Existing User: As the UserId exists in DB table, it may check for the status.

If the status is ‘deactivated’, user may not be allowed to enter the system and show a message on login page as “User Doesn't have access to the system”

If the status is ‘disabled’, user may be redirected to a page showing the message “Please ask User Admin to provide access to the system”

If the status is ‘enabled’, it may check for the UserRole—

If the UserRole is System Admin or UserAdmin, user may be redirected to the User-Script page. In header section, left part may have the link to the same page and right part may have a User Account drop down. Drop-down may contain link to User-List page and logout.

If the UserRole is Normal User, user may be redirected to the User-Script page. In header section, first section (e.g., left part) may have the link to the same page and a second section (e.g., right part) may have a User Account drop down. Drop-down may contain only logout link.

C. Approve User:

The precondition for this user function is that the User Admin or System admin has already logged into the system with their valid online identification (ID). The requirements for the User to approve are as follows:

The System Administrator or User Administrator may click user account drop down list and select the User List.

The user List may display all the Users along with the inactive users list.

The System/User Administrator may go to the Inactive user list and select the user to make active.

System/User Admin may be able to change the status of the User (Enable/Disable/Delete) by toggling the radio button;

On change, user may be prompted to confirm if they want to change the status of the user.

On confirmed User Status may be updated in database if the status is updated to active.

Once updated, a success message may show in screen.

D. Approve User Admin:

The precondition for this user function is that the System admin has already logged into the system with their valid online ID. The requirements for the User for user creation are as follows:

The System Administrator may click user account drop down list and select the User List

The user List may display all the Users along with the active users

The System may go to the active user list and select the one from role drop down to change role

On change, user may be prompted to confirm if they want to change the User Role

On confirm, User Role may be updated in database table

Once updated, a success message may show in screen

The System may change the role of that active User ID to User Admin having all the privileges

The system may also set different privileges to UserAdmin.

In another embodiment, the Master Template Management 136 may perform the following:

The System Admin may be able to create new table in VIP Master Templates;

The System Admin may be updating the exiting DB table; and

The System Admin may delete the table as when needed.

The precondition for Create, Update and Delete Master Template user function is that System admin may be ready with both Execution Scripts and Rollback Scripts since it may not be performed through UI instead it may be executed through DB Scripting, which may contain all the associated commands for CRUD functionality as when required for MYSQL database. In case Execution scripts fails, Rollback scripts need to be executed. The requirements for the User for user creation are as follows:

A. Create Master Template

System Administrator may login to the DB Server with valid credentials.

System Administrator may run the MASTER TEMPLATE creation scripts to create new tables.

B. Update Master Template

System Administrator may login to the DB Server with valid credentials.

System Administrator may run the MASTER TEMPLATE update scripts to make any changes on existing tables.

Any changes made in the table may be reflected through View Master Template component.

C. Delete Master Template

System Administrator may login to the DB Server with valid credentials.

System Administrator may run the MASTER TEMPLATE Deletion scripts to delete new tables.

In one embodiment, user creation may include:

D. View Master Template

Used by all the actors of the system to view the Baseline Master Template. It is also an inclusive Component of Create, Update and Delete Master Template.

Clicking on a transaction may open the message editor in modal pop up in read-only mode, where user may be able to view the message format and all the fields in tabular format.

In another embodiment, the system 100 may include the online integrator 132 which may integrate the existing client-based application to the online portal so that a user with the valid online login credential [User ID and Password] may able to access the token services of the system 100. The process has been described as mentioned below with following assumptions—

Assumptions: User may have valid & unique ONLINE user ID and password.

User may login to the online website with their individual User ID and Password.

The user may authenticated by online whether they are valid user and have the privilege to access the Token services of the system 100.

Once the authentication is done and successful, the user may access Token services of the system 100.

Upon first login, User may be validated by application level Role Authorization to access the system.

In one aspect, during first time accessing the Token services of the system 100—It may be necessary for the parameters from the online portal and may save those parameters into the Database. The parameters includes, in one embodiment, UserId, Name, Email ID, Region, etc., as per customization required.

As discussed with online group there is no such common group ID for ONLINE Login thereby a single unique id is required for everyone. But the system 100 may group up the IDs at applications end, based on input coming from online like region or user-group.

Referring back to the master DB generator 102, the master DB generator 102 may aim to generate the associated databases of the scripts based on the articles number provided. In one embodiment, the master DB generator 102 may be Accessed by User Admin, such as an authorized team member, and System Admin, such as an authorized development team, only.

User Admin/System Admin may upload the latest Article number along with through Excel sheet to the Token services of the system 100.

System may read the data from Excel sheet and may populate the associated articles present for a particular Basic Encoding Rules (BER).

Other way round is that the article number may be key entered to update the details of the associated article number.

Now User Admin may Select the criteria as per need to generate the database as per the selection mentioned the page with the following questionnaire applicable for that article applicable:

Region

Member Type

Host Type

Client Type

Card Type

Form Factor

In another embodiment, the master DB generator 102 may include the message types and its criteria that are impacted with the changes.

For each article and for each BER this table needs to be updated through key Entry or similar excel sheet like stripy may be uploaded to fill the criteria for the same.

Once this table is filled up and the selection is made—then Master DB is ready to generate tease DB.

Next, the Admin may select the “Create Database” to create the databases based on the combination selected.

The Test databases may be created based on the criteria for each articles number provided sequentially.

The Test databases may be modified and may be edited by user Admin as needed.

Those Test databases are created—it may be persisted in our MySQL-Database as Baseline for that BER.

Each Test database may have their own configuration & properties so that the messages may be modified quickly.

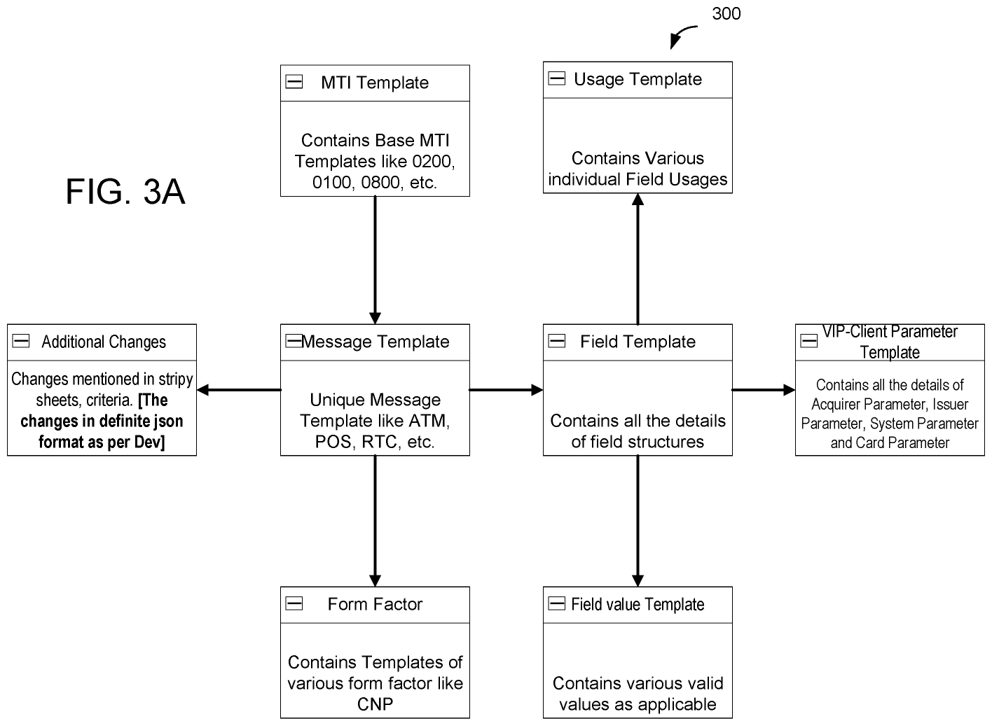

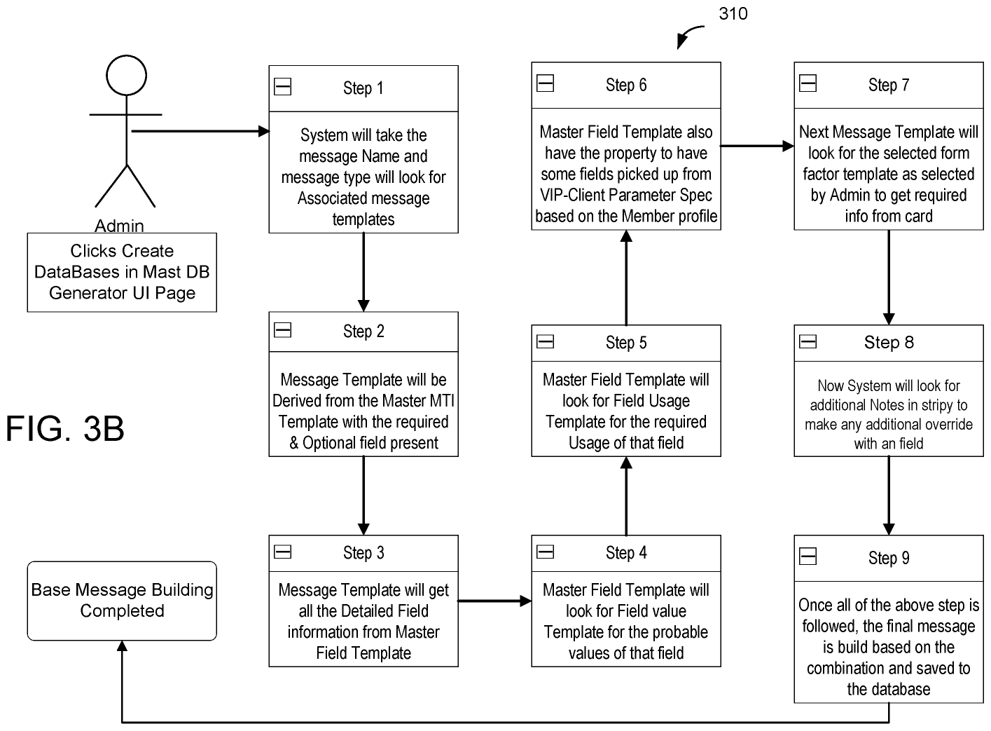

In one embodiment, the master DB generator 102 may generate elements of the database (e.g., in response to the user's selection or invocation of the “create database” button 212) based on invoking various templates, such as those shown in a diagram 300 in FIG. 3A. FIG. 3B further illustrates steps to build a base message structure for the database that has been created.

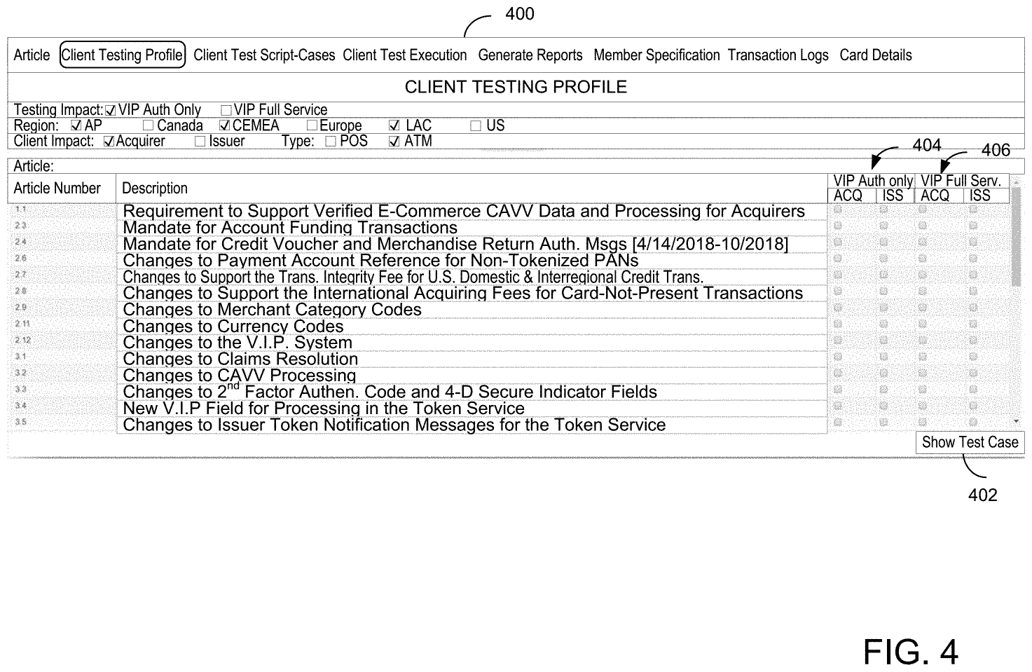

Referring to FIG. 4, a GUI 400 for enabling a user to create a testing profile may be illustrated. In one embodiment, the GUI 400 may enable the user to enter a plurality of parameters as shown to configure a test condition for the card reader (not shown). In one embodiment, the client testing profile tool 106 in FIG. 1 enables the user to configure and filter the client testing profile parameter based on the article number selected so that the associated test Cases/Scripts may be generated from this filtered input.

In one embodiment, once the user logins to a token service online web tool, the user may be redirected to this page shown in FIG. 4. For example, the GUI 400 may be a screen that may be presented to the user after logging in via the GUI 202 in FIG. 2B. This token server online web too approach may differ from prior approaches in that the user is required to install a client-side application that does not support a web portal. As such, the client-side application may be required to install all the necessary configurations locally and entered manually. When the testing is needed, the user may need to configure individually for each testing article.

Aspects of embodiments provide a flexible portal to the user so that the user may select the criteria to filter put the articles they want to test. For example, the filter criteria may include the following parameters:

Region—AP/Mayada/CEMEA/Europe/LAC/US;

Member Type—Auth Only/Full Service;

Client Type—Acquirer/Issuer; and

Merchant Type—ATM/POS.

In one embodiment, once the user selects the one or more criteria, the user may get the required articles—to generate the Test Script/databases.

Based on the GUI 400, the user may select the multiple articles to generate the associated Databases. Next, the User may select the “Show Test Case” button 402 to create those selected.

The Test cases & Script generator 108 may be called so that the test cases and script may be created based on the criteria for each articles number provided.

In one embodiment, suppose the user wishes to test according to an acquirer configuration, the user may in columns 404 and 406 select the appropriate checkbox to enable or disable the acquire testing. Similarly, the user may do the same for the issuer testing by selecting the appropriate checkbox. In one embodiment, enabling the acquirer testing enables an identification of a source station ID based on client profile on client test script cases screen. In another embodiment, enabling the issuer testing enables an identification of a destination station ID based on client profile on client test script cases screen.

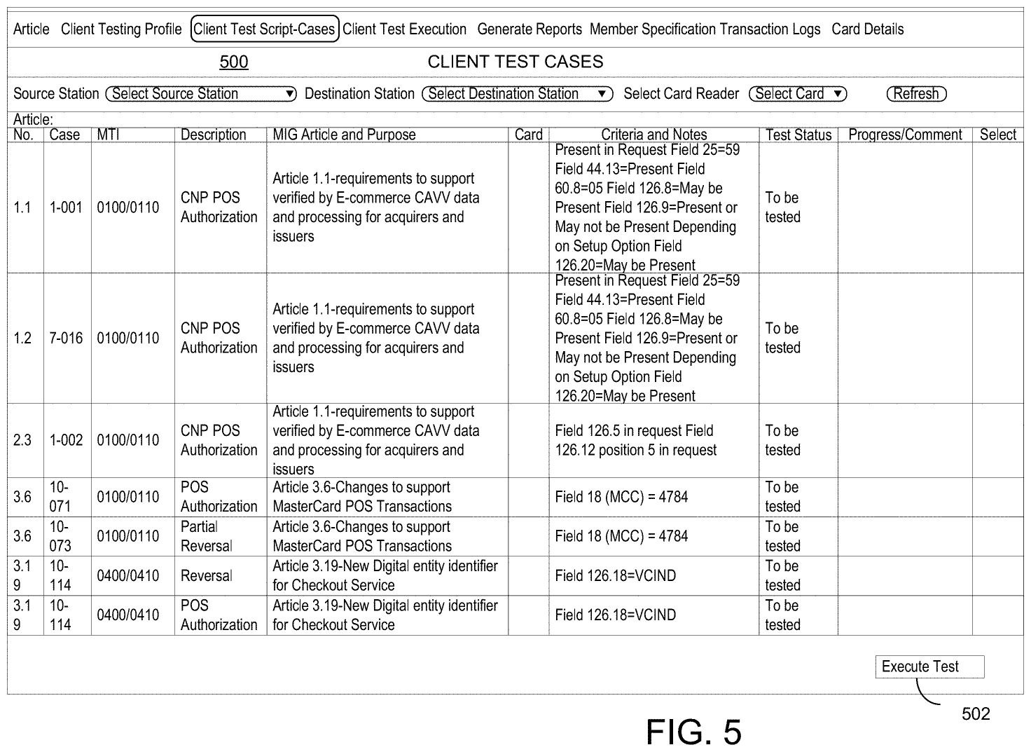

Referring now to FIG. 5, a GUI 500 for enabling a user to execute client test script-case via the Test Script-Case Generator 108 may be illustrated. In one embodiment, the test script-case generator 108 may accept client test profile from the previous GUI 400. Based on the selection and the filter from the GUI 400, the system 100 may generate and create the associated test script and cases. These script and cases may be displayed in a table format as shown in FIG. 5 in the GUI 500. As such, the user may use a pointing input device (e.g., a mouse, a touch pad, a stylus, a user's finger, or a user's voice command) to select any of the test cases presented on the GUI 500. Once, selected, the master DB generator 102 may create the requested test DB and the test case and script for the associated transaction may be executed when a button 502 “EXECUTE TEST” is selected. In one embodiment, the user admin may modify or edit the test cases and scripts as needed.

As discussed if user modification is necessary—(e.g., if a user needs to change a dollar amount, then they should be able to do that without user admin. In one embodiment, the system 100 may provide a list of frequently modified fields so that that field can be allowed in UI page to modify quickly with going VIP-Member specification section for editing. In one aspect, the required fields which may need to be changed or modified can be done through VIP-Client Specification UI page.

In one aspect, service based value lookup will be available to only allow values that may work on the particular transaction type for that field to modify. In one embodiment, admin may allow client to modify the fields as per their needs.

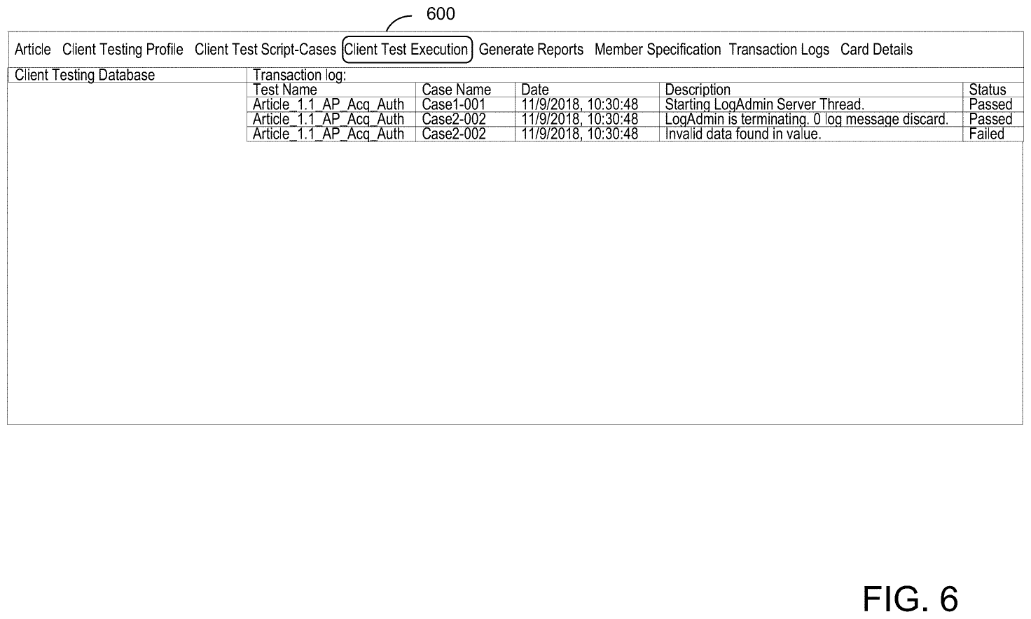

Referring now to FIG. 6, a GUI 600 may enable a user to obtain or associate transactions based on the client profile and the selected article number according to one embodiment. In one embodiment, the Client Test Case-DB Executer 110 may provide a log of the transactions associated with the test shown. In one embodiment, the client test case DB generator 110 may indicate the transaction what has been run so far with the status PASS OR FAIL or REJECT.

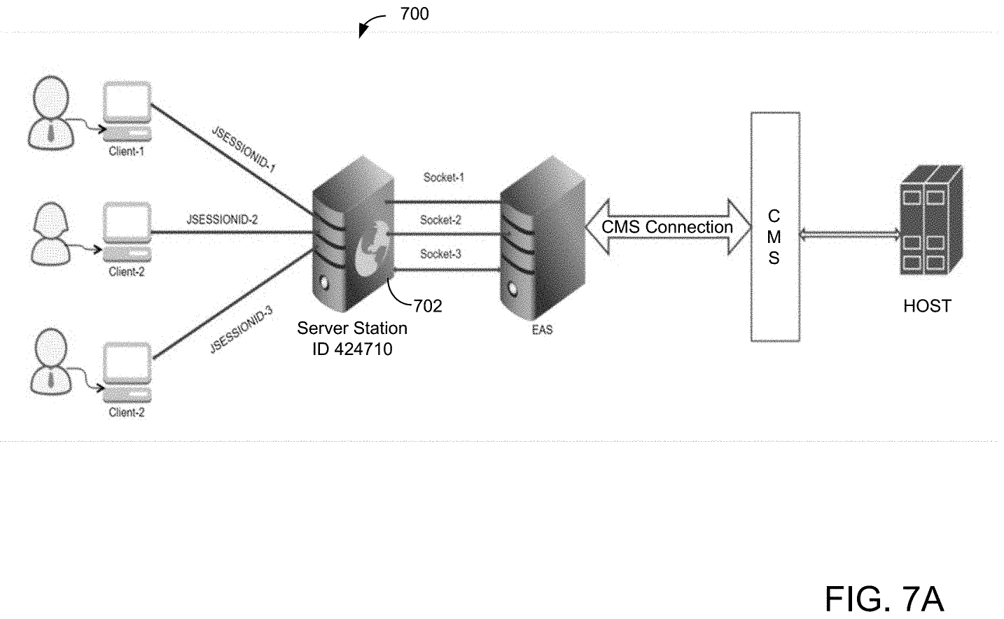

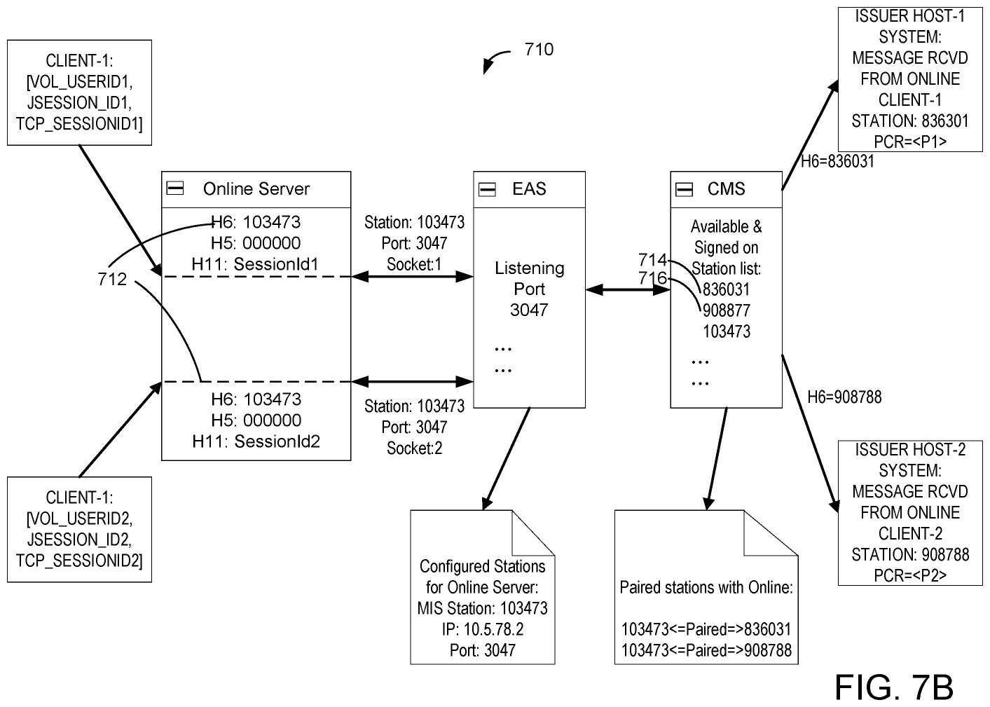

Referring now to FIG. 7A, in one embodiment, a diagram illustrates the client host connector 126 to create a virtual system, such as a VPARs environment. For example, in this configuration, the client host connector 126 may configure a test environment by having a host acting as an acquirer.

In such an implementation, in one embodiment, the user may login to the system 100 and without the user to specifically request a server ID as in the prior practices, the system 100 may assign or provide a destination station ID. In the example shown, the destination station ID may be “SERVER STATION ID 424710” 702. In addition, a user unique JSessionID may be created and the system 100 may track unique JSessionID with individual UserId. In addition, the client host connector 126 may create a unique socket connection between the destination station ID with an extended access service or server. In one embodiment, the extended access service or server may provide, in this test environment, a secure way to mimic the real world transaction situation where transactions are tokenized and passed through a payment processing network processor (e.g., the system 100).

In one embodiment, once the unique socket connection is created for each user, the client host connector 126 may map those unique socket session IDs with JSessionIDs to keep track with individual users. In another embodiment, the system 100 may then need the destination Station ID where the transaction will be sent & routed in the virtual testing environment. In another embodiment, once the transaction is sent successfully, the response of the transaction may be routed back to the same session connection with its mapped JSessionID to route to the correct user.

In one embodiment, the system 100 may populate MIS as defined with the extended access service as a source station and populate 00000 as destination station to send the transaction to the certification management service. In another embodiment, the system 100 may route the transaction to an issuer host or will response back in STIP mode.

On the one hand, if the stations are paired in 1-to-Many paring mode (e.g., between VATP Station & Client Host Station), then the certification management service may force route the transaction that particular client station. Once the transaction is sent successfully, the response of the transaction will be routed back to the same session connection with its mapped JSessionID to route to the correct user.

As a further illustration, a flow diagram 710 in FIG. 7B demonstrates the data flow in the acquirer test mode. For example, as shown in FIG. 7B, in a one-2-Many Station Pairing Mode, the system 100 may enable two clients, client-1 and client-2, to run the system 100 to test transactions in an acquirer mode. The system 100, may create a station [103473(MIS)] 712 and client Host Stations 836031(Host1) 714 and 908788(Host2) 716 are paired in one-to-Many Pairing Mode. In this embodiment, the station for example 103473(MIS) has been preconfigured in EAS for VTSOnline Server, which has a definition in Baseline global loaded in the certification management service. In one aspect, a separate and unique connection/session with same station for each acquirer client.

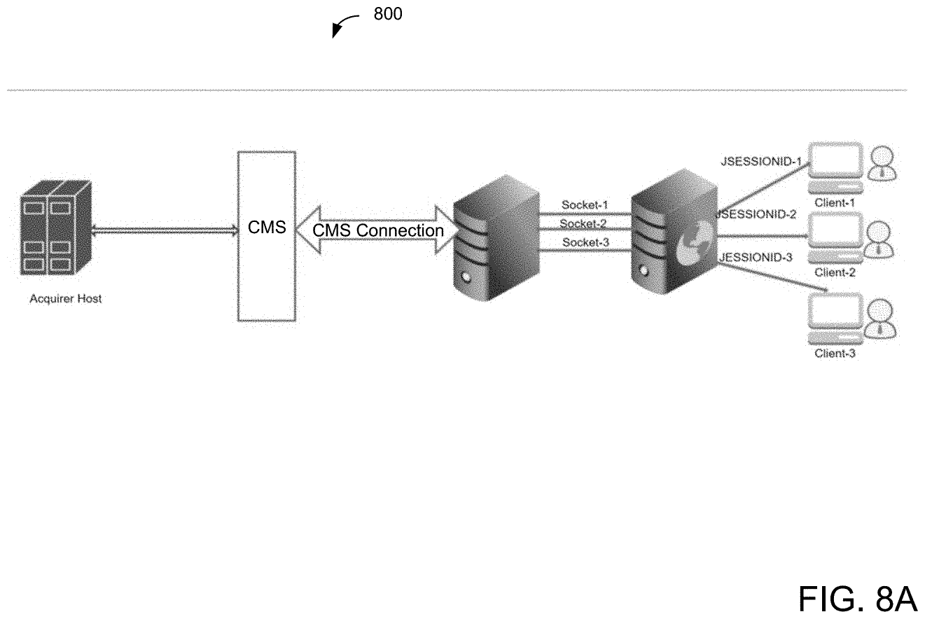

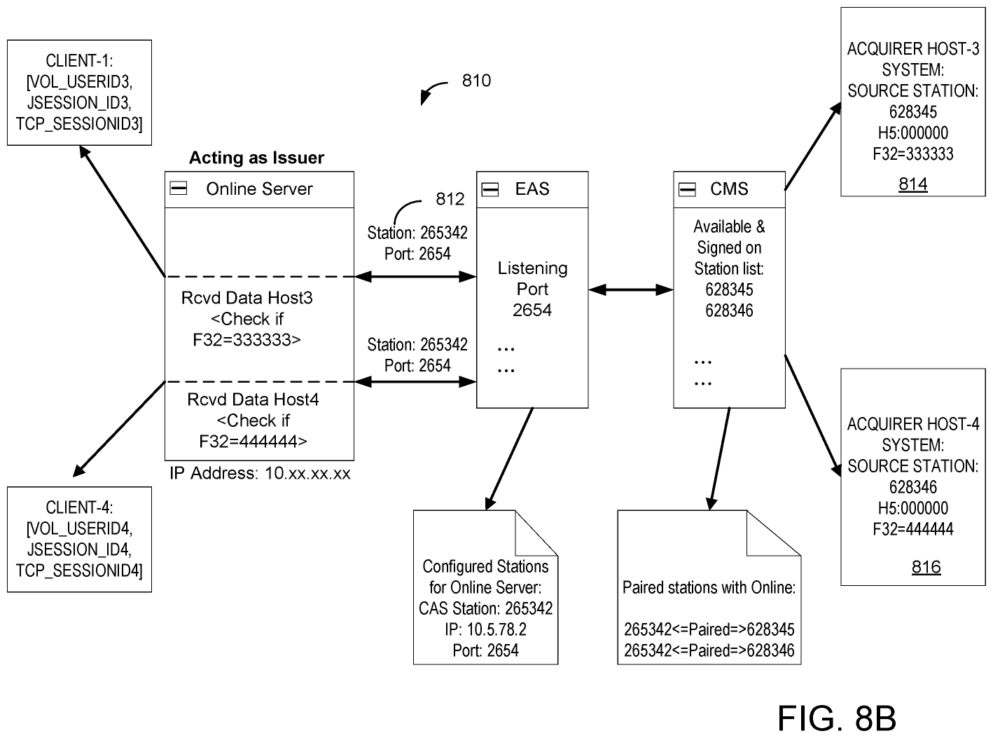

Referring now to FIG. 8A, a diagram 800 illustrates that the client host connector 126 may create a testing environment for the user to test the articles with the system 100 acting as an issuer. In such an embodiment, the user may login to the system 100 and the client host connector 126 may provide a source station ID from where transaction has been originated. Once logged in, for each user, a unique JSessionID may be created and this JSessionID may be mapped with the Source Station ID. The client host connector 126 may a create necessary server socket that wait for an incoming transaction in the testing environment. Once an incoming message is received—it may parse and check for H5 to match source station id. In one embodiment, once the source station ID is matched, the system 100 may forward to the respective JSessionID to respond those incoming request. With such configuration, the system 100 may respond to requests with correct outgoing response message with the socket connection already made.

Referring now to FIG. 8B, a flow diagram 810 illustrates an implementation of a One-to-Many Station Pairing Mode for allowing the user to run test transactions as an issuer via the system 100. In one embodiment, the system 100 may create or assign a 265342 (CAS) station 812 and client Host Stations 814 and 816 (e.g., 628345(Acquirer Host1) & 628345 (Acquirer Host2)) for paring in one-to-Many Pairing Mode. In one embodiment, the station 812, for example 265342(CAS), has been preconfigured in EAS for a server under the system 100, which has a definition in Baseline global loaded in the certification management server.

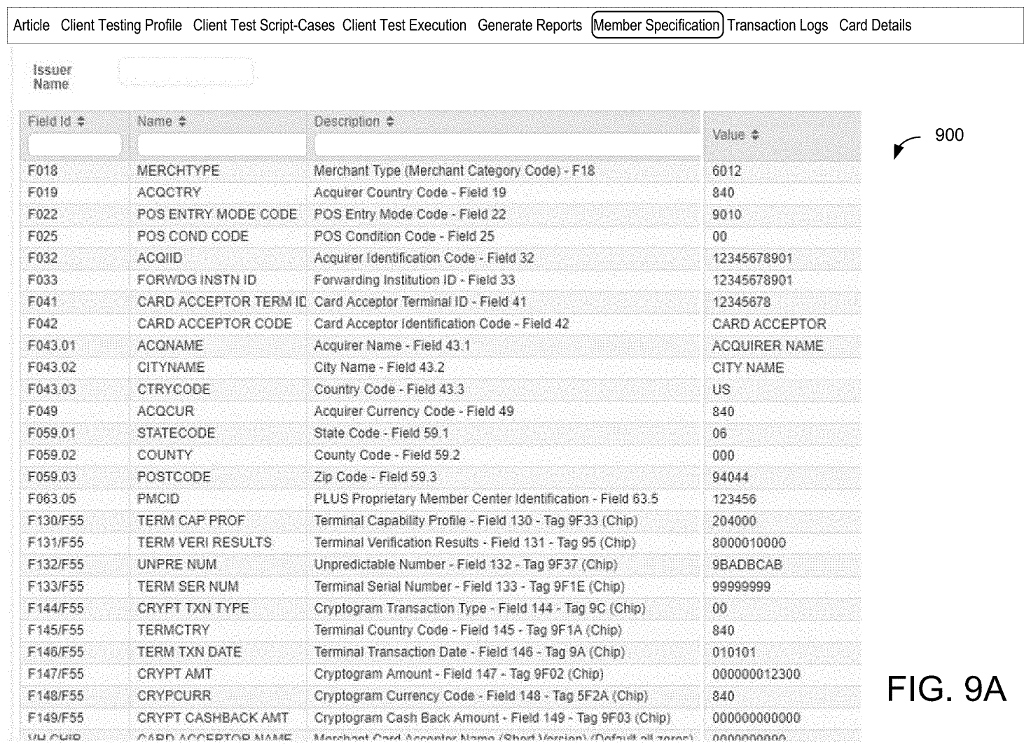

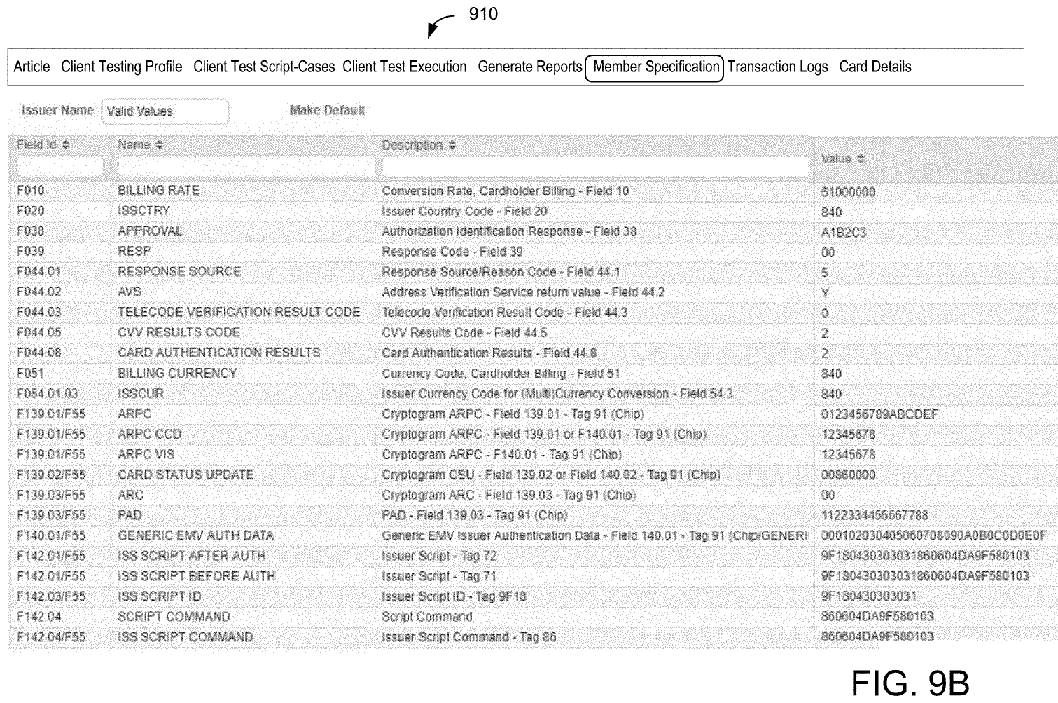

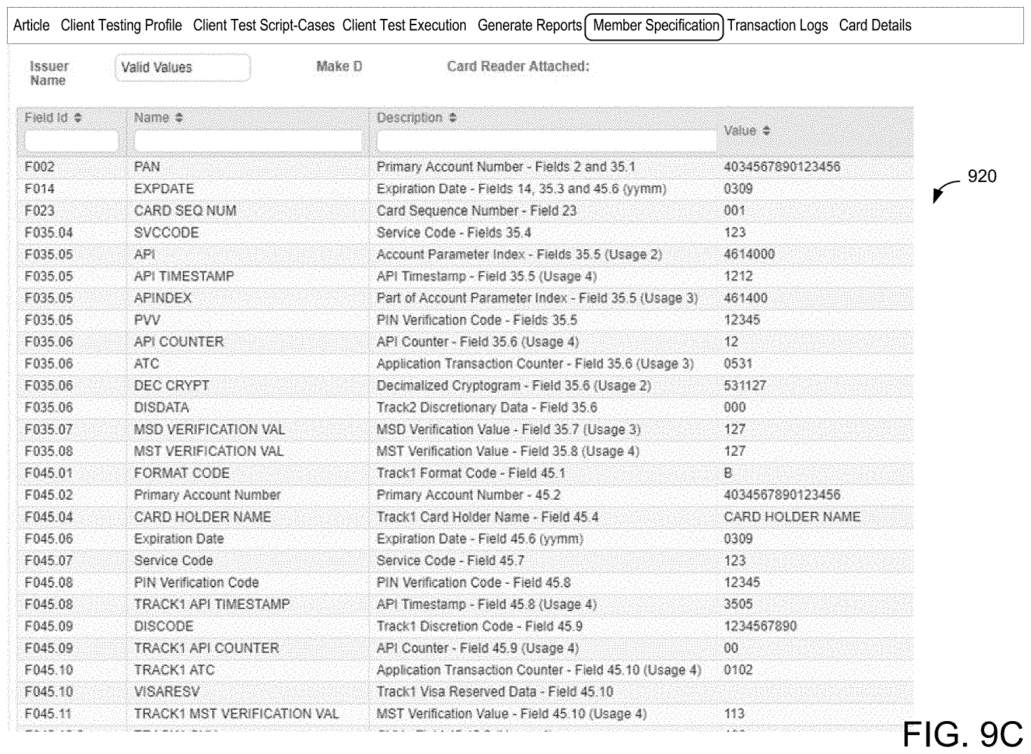

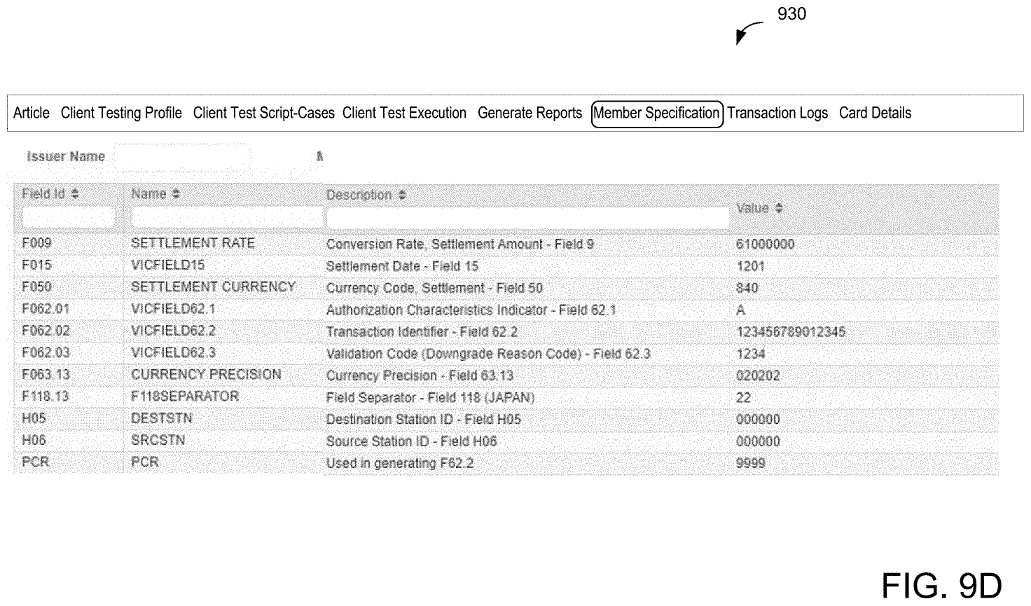

In one embodiment, when the user uses the system 100 to act as an issuer, as a part of testing or customizing test of transactions, the system 100 may route the message from Acquirer Host station through the certification management server as it has already been in pairing mode. In one embodiment, the GUI (as those UI presented here in the application) may include an option to enter Acquirer Institution ID [F32] (one of the parameters as shown in FIG. 9A) for uniquely identifying an Acquirer.

Due to the testing environments in FIGS. 7 and 8, the system 100 may include the specifications handler 114 to display and include a variety of specifications to facility the testing. For example, as shown in FIGS. 9A to 9D, different sets of specifications may be presented or provided to the user as part of the testing. For example, FIG. 9A illustrates a GUI 900 showing a set of acquirer specifications as managed by the acquirer group specifications 118. Similarly, the issuer group specifications 124 may provide a set of specifications for the user in a GUI 910 to configure as part of the testing having the system 100 to act like an issuer in FIG. 9B. Also, the card group specifications 128 may provide a GUI 920 having a set of specifications in FIG. 9C. Referring to FIG. 9D specifically, a GUI 830 illustrates a set of system specifications for the system 100.

In one embodiment, a user may, in FIG. 9C, have a list of devices in a drop down menu (not shown) in a left pane so that the user may select one for testing purposes. In another embodiment, the GUI 920 may present a default value for each of the fields in the value column in FIG. 9C.

In another embodiment, the system 100 may provide additional features in the GUIs in FIGS. 9A to 9D. For example, the system 100 may enable the user of the system 100 to save or update the groups or profiles that the user has established. For example, for testing a particular device or for testing an acquirer specification, the user may create a profile for specifications of the particular device or the acquirer. The user may SAVE, SAVE AS, or UPDATE the profile in these GUIs in FIGS. 9A to 9D.

In one embodiment, the smart chip card handler 130 may be designed to handle testing of payment devices with a smart chip. As part of the testing, to read card data from a smart chip card in both contact and contactless mode, the system 100 may support different readers, such as:

Magtek for Magstripe Card reader[Both Keyboard And HID Mode];

GemPC Twin Contact Chip Card Reader [EMV Compliant];

QProx/QP3000S Contactless Chip Card Reader [EMV Compliant];

Dual Interface Chip Card readers [EMV Compliant];

Identiv's CLOUD 4700 F;

uTrust 4701.

In addition, the system 100 may also support barcode reader:

Honeywell Xenon 1900GHD-2USB Barcode Scanner;

Zebra DS9208-SR4NNU21Z Barcode Scanner; and

CVN version : CVN10, CVN17, CVN18, CVN22, CVN43

As appreciated by the user, unlike the prior client-side application, if there are any updates to the specifications in FIGS. 8A to 8D, the user may need to particular fetch or download the updates. Otherwise, the testing from the client-side application may not be processed properly. Moreover, if the specifications have been updated, the prior client-side application may not have been updated to the correct version. As such, it leads to various problems when the user wishes to test a card reader, an ATM, or a POS device because the issues won't be discovered in real-time. Rather, the user may need to troubleshoot the issues laboriously and may be inefficient.

In one embodiment, the system 100 may create an easy deployable client

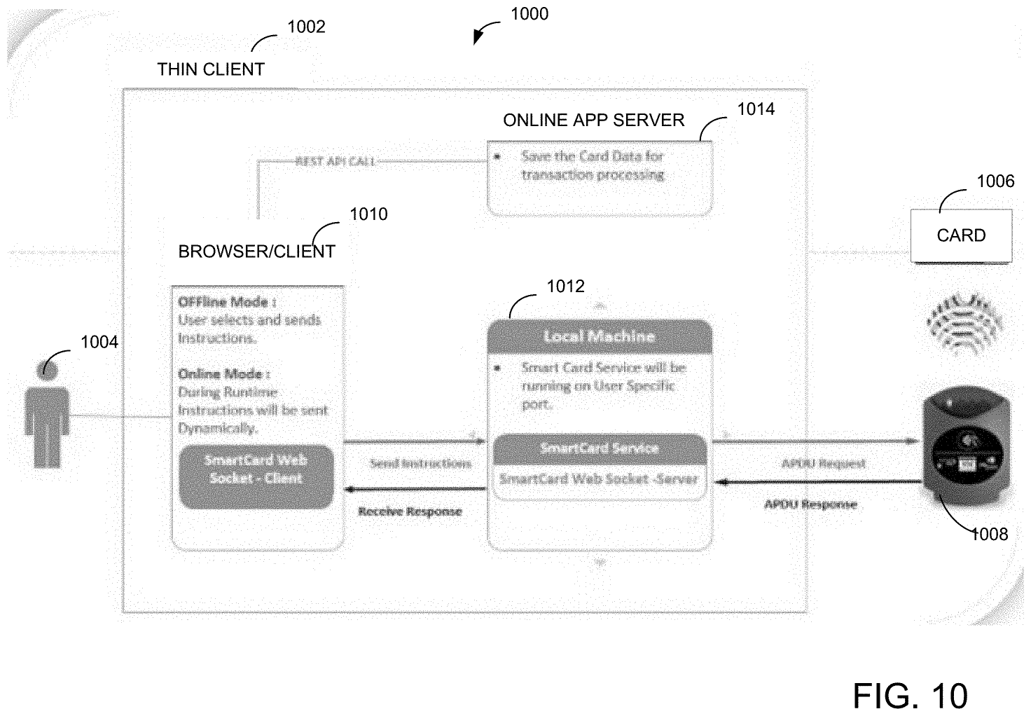

GUI for the user when dealing with card readers of various types and generation. To further illustrate the sub-system, FIG. 10 illustrates a subsystem 1000 that may conveniently handle the card reader testing tasks. FIG. 10A illustrates an exemplary GUI 1000 as shown a web browser for handling such testing requests from the user and FIG. 10B illustrates an exemplary GUI 1010 showing an output screen of a thin client application.

As an overview, the subsystem 1000 may process receiving data from a smart chip card successfully attached through USB device and populate those data to the client browser via the online portal provided by the system 100. In one embodiment, the user may use a desktop computer or a laptop computer with peripheral connections such as USB connection and relevant connectors or cables to connect the computer to the card reader device so that the reader may retrieve or read data from the smart chip. In prior approaches, after the reader's driver is installed, depending on the websites, web hosts typically may send an encryption application to be installed on the user's device. This may achieve its goals to ensure the communication between the web hosts and the device is secured. However, if the browser of the user device fails to support such external application, the user may not be able to gain access to the website and thus not able to send the data from the card itself.

Aspects of embodiments of the system 100 and the subsystem 1000 may provide a thin client that may be running on a client machine responsible to receive the data from client machine and send to web tool browser.

In one embodiment, as discussed above, a web browser installed on a given computer or machine may be limited in its ability to transfer read data from cards to a remote host. As such, the subsystem 1000 may include a thin client application running on a client machine where components and tools as discussed above of the system 100 may be running via the web browser. In one embodiment, the thin client application may communicate with web pages rendered on the web browser via websocket and provide functionality that prior approaches with the client-side application may achieve.

In one embodiment, the thin client application 1002 may be written in C/C++ programming language/Service [Manually Invoked/Auto Run Executables] which may be running locally into user's workstation through some unique PORT. In one embodiment, a user 1004 may perform a one-time initial installation of the thin client application 1002 on his or her local computer. As discussed above, the system 100 may aim to provide flexible and convenient means to enable the user to test new card readers or reading devices. As such, in addition establishing an account with the system 100 above on an online portal, the thin client application 1002 may provide a secure but also channel to test various aspects (as described above) of the card reader to be tested. In another embodiment, instead of installing the thin client application 1002, the user 1004 may elect to download the following set of files:

TokenServiceOnlineCardReaderUtilityClient.exe : Main Client Application;

Supporting files:

msvcp140d.dll

MTUSCRA.dll

Ucrtbased.dll

vcruntime140d.dll

XPROXAPI.dll

It is to be noted that the library files (DLL) may provide and create the needed websocket connections per websocket protocol and/or application programming interface (API) as indicated above.

In one embodiment, the thin client application 902 may support one or more of the following types of devices:

A. Magstripe Reader:

Magtek (both Keyboard+HID Mode)

B. Contactless Reader:

QProx/QP3000S

Identive CLOUD 4700F Reader[Dual]

C. Contact Reader:

Identive CLOUD 4700F Reader[Dual]

GemPC Twin

D. Barcode Reader:

Zebra DS9208 Scanner

Honeywell Xenon 1900GHD-2USB Scanner

E. Other Reader:

Smartcard readers—Broadcom, Active identity

It is to be understood that other supported devices may be added without the need for the user to reinstall or the client application 1002 to have a connected reader tested.

In another embodiment, the thin client application 1002 may further support configurations from the user 1004. For example, support for PDOL (Processing Options Data Object List) Tags with below two options may be provided:

Auto/Default PDOL Value and

Ask for Input if PDOL Required.

For terminal transaction qualifiers (TTQ):

qVSDC (TTQ: 26800000);

MSD with CVN (TTQ: 86800000);

MSD without CVN (TTQ: 86000000); and

User Defined TTQ.

In another embodiment, user may supply acquirer specifications. For examples, the following may be some of the default values and may be modified based upon requirements:

CRYPT AMT=000000012300

CRYPT CASHBACK AMT=000000000000

TERMCTRY=840

TERM VERI RESULTS=8000010000

CRYPCURR=840

TERM TXN DATE=010101

CRYPT TXN TYPE=00

UNPRE NUM=9BADBCAB

MERCHTYPE=6012

CARD ACCEPTOR NAME=0000000000

MCARD PUR CRYPT=0000000000000000

MCARD TRACE NUMBER=00000000

TRANS CODE=53

TXN PIN=1234

VH CARD ACCEPTOR ID=000000000000000

Moreover, application identifier (AID) support may be provided. In one embodiment, the user may select a list of AIDs for the cards. The following is an exemplary list of supported AIDS:

A0000000032020—VPay

A0000000030201—Canadian Visa Debit

A0000000030005—Visa Vale

A0000000031010—Visa

A0000000032010—Electron

A0000000033010—Interlink

A0000000036010—Domestic Visa Cash Stored Value

A0000000036020—International Visa Cash Stored Value

A0000000037010—Visa Horizon

A0000000038002—Dynamic Passcode Authentication

A0000000038010—PLUS

A0000000039010—Loyalty

A000000003999910—Proprietary ATM

A0000000041010—MasterCard

A0000000043060—Maestro

A00000002501—AMEX AIEPS

A0000000291010—AMEX AIEPS ALIAS ID

A0000000980840—Visa USA

A0000001523010—Discover

A0000000042203—Maestro

A0000000030704—Visa Fleet North America

A0000000034010—Visa Fleet AID

A000000241010101—China 1

A000000241010102—China 2

A00000000307010001—Private Label Payments

A0000006021010—NSICCS ATM/Debit

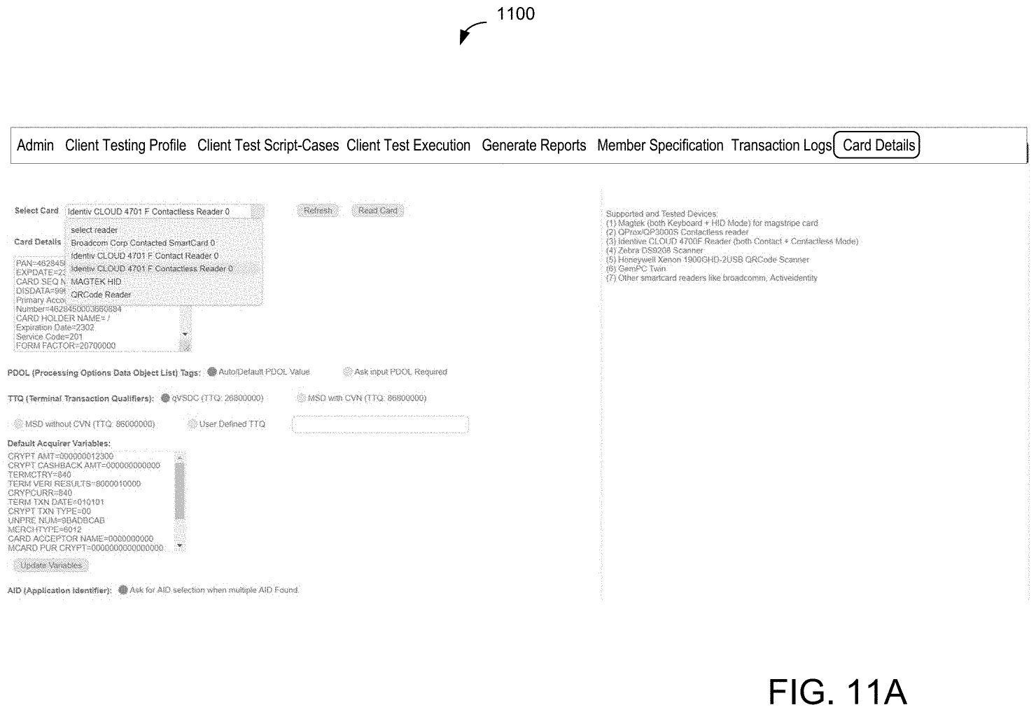

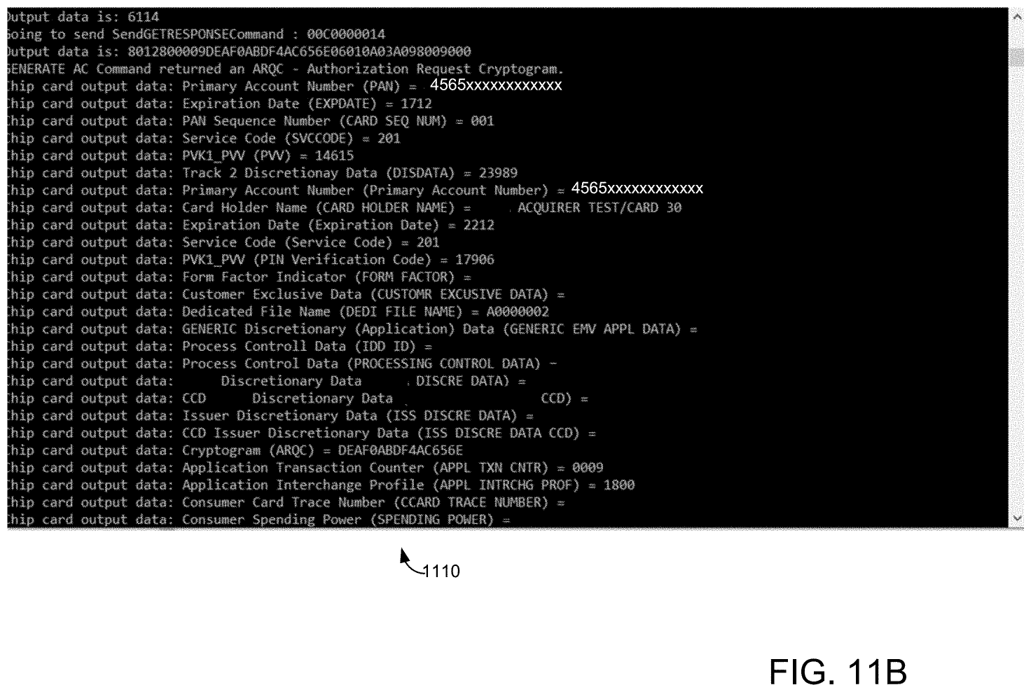

In one embodiment, the GUI 1100 in FIG. 11A may provide an interactive web portal to configure these various settings. In another embodiment, the GUI 1110 in FIG. 11B may provide a readout or “echo” of the various outputs based on the testing of the card 1006 as read by the card reader 1008.

Referring back to FIG. 10, the thin client application 1002 may communicate with the card reader 1008. For example, such communication may include communicating with a device driver of the card reader 1008. In another embodiment, the thin client application 1002 may also send associated application protocol data unit (APDU) commands as required.

In one embodiment, the card reader 1008 may capture data from the card 1006. Once the data is captured, the thin client application 1002 may be ready to send the required data to the system 100 through Websocket protocol.

Before sending such data packet, a browser 1010 at the client device may receive the data sent by application running locally [Websocket Server 912] as requested or on demand. In one embodiment, the browser 1010 may be offline. As such, the browser 1010 may not send the data in real-time and will hold such transmission until the browser 1010 is online. If the browser 1010 is online, the data packet may be send dynamically or substantially in real-time.

In one embodiment, as indicated above, the user 1004 may have an online account with the system 100 so that the user 1004 may access one or more of the subsystems, components or tools shown in FIG. 1, via a web browser (e.g., the browser 1010). At the same time, once the thin client application 1002 is executed and running and has detected the presence of a card reader (e.g., the card reader 1008) and the data from the card 1006, aspects of embodiments may populate the received data to the appropriate web portal where the data is needed. In one embodiment, the card data may be posted through REST API call to a token service online application server 1014 for further processing or persisting the data.

In one example, the thin client 1002 may execute one or more of the following components to achieve the above operations:

1. Connect ( )component/function:

To perform the handshaking with the web socket server running on a local machine on specified port.

A client may start the WebSocket handshake process. The client may send a standard HTTP request that looks like this (the HTTP version must be 1.1 or greater, and the method must be GET):

In one embodiment, the following sample request header may be used during Hand Shaking from the client:

GET ws://localhost:4200/sockjs-node/858/omigsjqo/websocket HTTP/1.1

Host: localhost:4200

Connection: Upgrade

Pragma: no-cache

Cache-Control: no-cache

User-Agent: Mozilla/5.0 (Windows NT 10.0; Win64; ×64) AppleWebKit/537.36 (KHTML, like Gecko) Chrome/69.0.3497.92 Safari/537.36

Upgrade: websocket

Origin: http://localhost:4200

Sec-WebSocket-Version: 13

Accept-Encoding: gzip, deflate, br

Accept-Language: en-US,en;q=0.9

Sec-WebSocket-Key: qVLqsabJGxN7eb0IRnUEJg==

Sec-WebSocket-Extensions: permessage-deflate; client_max_window_bits

In another example, a sample response header during Successful Hand Shaking from WebSocket Server running on local Host may be received:

Response Header: source view

HTTP/1.1 101 Switching Protocols

Upgrade: websocket

Connection: Upgrade

Sec-WebSocket-Accept: F+Vdz+ZrNoLFGVmMvNzzQtksiNg=

2. Send Instruction ( )component/function:

In one embodiment, the thin client 1002 may send the instructions to get the required data from smart card Sever. The instructions may include the following—

“GetDeviceList( )”—getting the list of devices attached to local machine

“ReadData(Device)”—Reading the card data details using selected Device

3. Disconnect ( )component/function:

To close the connection.

To close a connection either the client or server may send a control frame with data containing a specified control sequence to begin the closing handshake.

Upon receiving such a frame, the other peer sends a Close frame in response. The first peer then closes the connection. Any further data received after closing of connection is then discarded.

In one example, the smart card web socket Server 912, may be a TCP application, listening on any port of a server (e.g., local machine) that may follow a specific protocol consisting of the following components:

1. a native C++ web socket server—including the entire existing card read functionality mentioned in SmartCard.dll, which have all supported compatible windows drivers.

2. Start ( ): Server may be started on particular IP & port and may be waiting for connection.

3. AcceptTcpClient ( ): This may accept connection from client and if successful, the handshaking may be completed.

4. Disconnect ( ): To close the connection.

To close a connection either the client or server may send a control frame with data containing a specified control sequence to begin the closing handshake.

Upon receiving such a frame, the other peer may send a close frame in response. The first peer then may close the connection. Any further data received after closing of connection is then discarded.

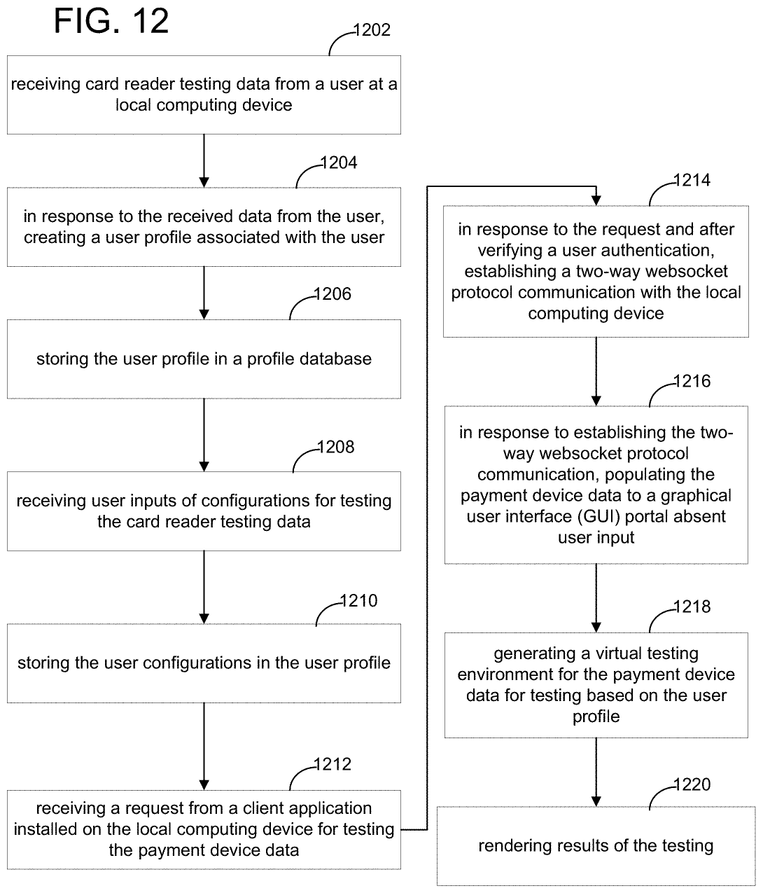

Referring now to FIG. 12, a flowchart illustrating a method according to one embodiment. At 1202, a system, such as system 100, may receive card reader testing data from a user at a local computing device. The card reader testing data includes payment device data obtained through the card reader. At 1204, in response to the received data from the user, the system 100 may create a user profile associated with the user. The system 100 may further store the user profile in a profile database at 1206. At 1208, the system 100 may receive user inputs of configurations for testing the card reader testing data, The configurations include specifications associated with at least one of the following: issuer specifications, acquirer specifications, card specifications, and smart chip card specifications. At 1210, the system 100 may store the user configurations in the user profile. In one embodiment, at 1212, the system 100 may receive a request from a client application installed on the local computing device for testing the payment device data. At 1214, the system 100, in response to the request and after verifying a user authentication, may establish a two-way websocket protocol communication with the local computing device. At 1216, in response to establishing the two-way websocket protocol communication, the system 100 may populate the payment device data to a graphical user interface (GUI) portal absent user input. At 1218, the system 100 may generate a virtual testing environment for the payment device data for testing based on the user profile. The system 100 may render, such as generating a report with results of the testing at 1220.

FIG. 13 may be a high level illustration of a portable computing device 801 communicating with a remote computing device 841 but the application may be stored and accessed in a variety of ways. In addition, the application may be obtained in a variety of ways such as from an app store, from a web site, from a store Wi-Fi system, etc. There may be various versions of the application to take advantage of the benefits of different computing devices, different languages and different API platforms.

In one embodiment, a portable computing device 801 may be a mobile device 108 that operates using a portable power source 855 such as a battery. The portable computing device 801 may also have a display 802 which may or may not be a touch sensitive display. More specifically, the display 802 may have a capacitance sensor, for example, that may be used to provide input data to the portable computing device 801. In other embodiments, an input pad 804 such as arrows, scroll wheels, keyboards, etc., may be used to provide inputs to the portable computing device 801. In addition, the portable computing device 801 may have a microphone 806 which may accept and store verbal data, a camera 808 to accept images and a speaker 810 to communicate sounds.

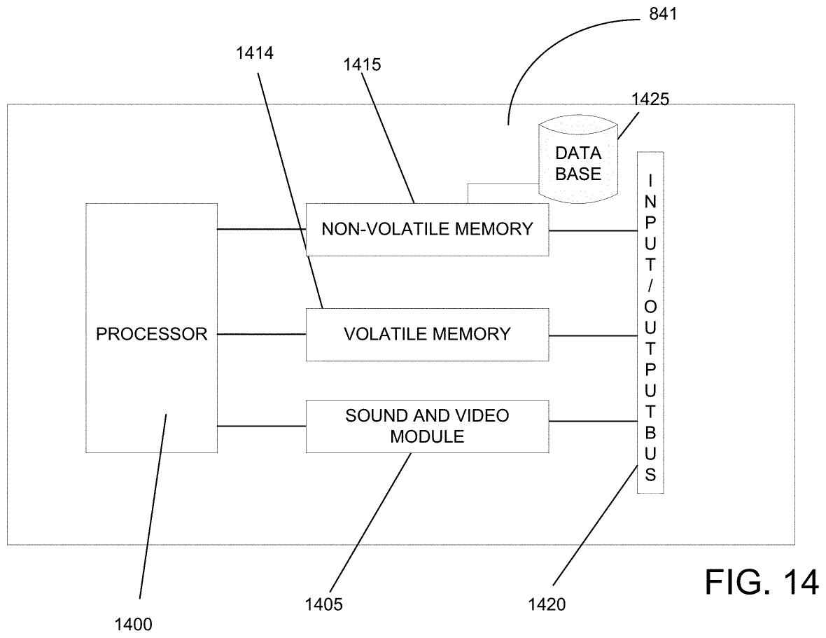

The portable computing device 801 may be able to communicate with a computing device 841 or a plurality of computing devices 841 that make up a cloud of computing devices 811. The portable computing device 801 may be able to communicate in a variety of ways. In some embodiments, the communication may be wired such as through an Ethernet cable, a USB cable or RJ6 cable. In other embodiments, the communication may be wireless such as through Wi-Fi® (802.11 standard), BLUETOOTH, cellular communication or near field communication devices. The communication may be direct to the computing device 841 or may be through a communication network 102 such as cellular service, through the Internet, through a private network, through BLUETOOTH, etc., FIG. 13 may be a simplified illustration of the physical elements that make up a portable computing device 801 and FIG. 14 may be a simplified illustration of the physical elements that make up a server type computing device 841.

FIG. 13 may be a sample portable computing device 801 that is physically configured according to be part of the system. The portable computing device 801 may have a processor 850 that is physically configured according to computer executable instructions. It may have a portable power supply 855 such as a battery which may be rechargeable. It may also have a sound and video module 860 which assists in displaying video and sound and may turn off when not in use to conserve power and battery life. The portable computing device 801 may also have non-volatile memory 865 and volatile memory 870. It may have GPS capabilities 880 that may be a separate circuit or may be part of the processor 850. There also may be an input/output bus 875 that shuttles data to and from the various user input devices such as the microphone 806, the camera 808 and other inputs, such as the input pad 804, the display 802, and the speakers 810, etc., It also may control of communicating with the networks, either through wireless or wired devices. Of course, this is just one embodiment of the portable computing device 801 and the number and types of portable computing devices 801 is limited only by the imagination.

As a result of the system, better information may be provided to a user at a point of sale. The information may be user specific and may be required to be over a threshold of relevance. As a result, users may make better informed decisions. The system is more than just speeding a process but uses a computing system to achieve a better outcome.

The physical elements that make up the remote computing device 841 may be further illustrated in FIG. 14. At a high level, the computing device 841 may include a digital storage such as a magnetic disk, an optical disk, flash storage, non-volatile storage, etc., Structured data may be stored in the digital storage such as in a database. The server 841 may have a processor 1000 that is physically configured according to computer executable instructions. It may also have a sound and video module 1405 which assists in displaying video and sound and may turn off when not in use to conserve power and battery life. The server 841 may also have volatile memory 1410 and non-volatile memory 1415.

The database 1425 may be stored in the memory 1410 or 1415 or may be separate. The database 1425 may also be part of a cloud of computing device 841 and may be stored in a distributed manner across a plurality of computing devices 841. There also may be an input/output bus 1420 that shuttles data to and from the various user input devices such as the microphone 806, the camera 808, the inputs such as the input pad 804, the display 802, and the speakers 810, etc., The input/output bus 1420 also may control of communicating with the networks, either through wireless or wired devices. In some embodiments, the application may be on the local computing device 801 and in other embodiments, the application may be remote 841. Of course, this is just one embodiment of the server 841 and the number and types of portable computing devices 841 is limited only by the imagination.

The user devices, computers and servers described herein may be computers that may have, among other elements, a microprocessor (such as from the Intel® Corporation, AMD®, ARM®, Qualcomm®, or MediaTek®); volatile and non-volatile memory; one or more mass storage devices (i.e., a hard drive); various user input devices, such as a mouse, a keyboard, or a microphone; and a video display system. The user devices, computers and servers described herein may be running on any one of many operating systems including, but not limited to WINDOWS®, UNIX®, LINUX®, MAC® OS®, iOS®, or Android®. It is contemplated, however, that any suitable operating system may be used for the present invention. The servers may be a cluster of web servers, which may each be LINUX® based and supported by a load balancer that decides which of the cluster of web servers should process a request based upon the current request-load of the available server(s).

The user devices, computers and servers described herein may communicate via networks, including the Internet, wide area network (WAN), local area network (LAN), Wi-Fi®, other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system are examples. Any device described herein may communicate with any other device via one or more networks.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures, including any servers, user devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above may be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of embodiments may become apparent to those skilled in the art upon review of the disclosure. The scope embodiments should, therefore, be determined not with reference to the above description, but instead should be determined with reference to the pending claims along with their full scope or equivalents.

One or more features from any embodiment may be combined with one or more features of any other embodiment without departing from the scope embodiments. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it may be understood by those of ordinary skill in the art having the present specification, figures and claims before them, that the corresponding structure includes a computer, processor, or microprocessor (as the case may be) programmed to perform the particularly recited function using functionality found in a computer after special programming and/or by implementing one or more algorithms to achieve the recited functionality as recited in the claims or steps described above. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one embodiments to the embodiments illustrated.

The present disclosure provides a solution to the long-felt need described above. In particular, the systems and methods overcome challenges dealing with the lack of bidirectional communications via the HTTP through a web browser when the client device wishes to have a dedicated channel but the responses might not deem proper under the HTTP protocol. Aspects of embodiments build a thin client application calling or executing a websocket protocol locally while still patching the web browser with the needed data for communications via the HTTP protocol.

Further advantages and modifications of the above described system and method may readily occur to those skilled in the art.

The disclosure, in its broader aspects, is therefore not limited to the specific details, representative system and methods, and illustrative examples shown and described above. Various modifications and variations may be made to the above specification without departing from the scope or spirit of the present disclosure, and it is intended that the present disclosure covers all such modifications and variations provided they come within the scope of the following claims and their equivalents.

What is claimed is:

1. A system comprising:
a remote server configured for receiving card reader testing data from a user at a local computing device, the card reader testing data comprising payment device data obtained through the card reader;
in response to the received data from the user, the remote server is configured to create a user profile associated with the user;
a remote user profile management database for storing the user profile;
a graphical user interface (GUI), coupled to the remote server, for receiving user configurations for testing the card reader testing data;
wherein the remote server is further configured to store the user configurations in the user profile;
in response to a request from a client application installed on the local computing device, a token service server for establishing a two-way websocket protocol communication with the local computing device;
wherein the request is triggered by a receipt of the payment device data at the local computing device via the client application when a connection between the local computing device and the card reader is established;
in response to establishing the two-way websocket protocol communication, populating the payment device data to a page of the GUI absent user input;
wherein the remote server is configured to generate a virtual testing environment for the payment device data for testing based on the user profile; and
wherein the remote server is configured to render results of the testing.

2. The system of claim 1, wherein the GUI is configured to receive the user configurations via a web browser.

3. The system of claim 1, wherein the client application is configured to receive parameters in compliance with processing options data object list (PDOL) or terminal transaction qualifiers (TTQ) in response to inputs from the user.

4. The system of claim 1, wherein the remote server is configured to generate databases for testing the payment device data in the virtual testing environment.

5. The system of claim 1, wherein the remote server is configured to automatically generate logical network mapping to the generated databases for the virtual testing environment.

6. The system of claim 1, wherein the virtual testing environment comprises a testing environment in an acquirer mode.

7. The system of claim 1, wherein the virtual testing environment comprises a testing environment in an issuer mode.

8. A computer-implemented method comprising:
receiving card reader testing data from a user at a local computing device, the card reader testing data comprising payment device data obtained through the card reader;
in response to the received data from the user, creating a user profile associated with the user;
storing the user profile in a profile database;
receiving user inputs of configurations for testing the card reader testing data, the configurations include specifications associated with at least one of the following: issuer specifications, acquirer specifications, card specifications, and smart chip card specifications;
storing the user configurations in the user profile;
receiving a request from a client application installed on the local computing device for testing the payment device data;
in response to the request and after verifying a user authentication, establishing a two-way websocket protocol communication with the local computing device;
in response to establishing the two-way websocket protocol communication, populating the payment device data to a graphical user interface (GUI) portal absent user input;
generating a virtual testing environment for the payment device data for testing based on the user profile; and
rendering results of the testing.

9. The computer-implemented method of claim 8, wherein the request is triggered by a receipt of the payment device data at the local computing device via the client application when a connection between the local computing device and the card reader is established.

10. The computer-implemented method of claim 8, wherein the GUI portal comprises contents rendered via a web browser.

11. The computer-implemented method of claim 9, wherein the client application is configured to receive parameters in compliance with processing options data object list (PDOL) or terminal transaction qualifiers (TTQ) in response to inputs from the user.

12. The computer-implemented method of claim 8, further comprising generating databases for testing the payment device data in the virtual testing environment.

13. The computer-implemented method of claim 8, automatically generating logical network mapping to the generated databases for the virtual testing environment.

14. The computer-implemented method of claim 8, wherein the virtual testing environment comprises a testing environment in an acquirer mode or an issuer mode.

15. A computer-implemented method comprising:
establishing a first connection a card reader and a local computing device;
in response to receiving payment device data at the card reader, establishing a websocket protocol connection between the local computing device and a websocket protocol server;
establishing a second connection between the local computing device and a remote token service server via a browser;
in response a user authentication being verified, transferring the payment device data received via the first connection to a page hosted by the remote token service server via the browser through the websocket protocol server; and
monitoring connections between the card reader and the remote token service server.

16. The computer-implemented method of claim 15, wherein establishing the first connection comprises establishing the first connection via a client application installed on the local computing device.

17. The computer-implemented method of claim 15, further comprising receiving a user profile hosted by the remote token service server.

18. The computer-implemented method of claim 17, wherein the page comprises testing parameters and specifications in a virtual testing environment retrieved from the user profile.

19. The computer-implemented method of claim 18, wherein the virtual testing environment comprises a testing environment in an acquirer mode or an issuer mode.

20. The computer-implemented method of claim 16, wherein receiving parameter displayed on the local computing device via the client application in response to transferring.
